(19) United States
(12) Patent Application Publication
(10) Pub. No.: US 2020/0305042 A1
(43) Pub. Date: Sep. 24, 2020

(54) INTEREST PACKET ROUTING IN INFORMATION CENTRIC NETWORKS

(71) Applicant: Intel Corporation, Santa Clara, CA (US)

(72) Inventors: S. M. Iftekharul Alam, Hillsboro, OR (US); Gabriel Arrobo Vidal, Hillsboro, OR (US); Ravikumar Balakrishnan, Hillsboro, OR (US); Kuilin Clark Chen, Hillsboro, OR (US); Zongrui Ding, Portland, OR (US); Venkatesan Nallampatti Ekambaram, Hillsboro, OR (US); Maruti Gupta Hyde, Portland, OR (US); Satish Chandra Jha, Hillsboro, OR (US); Stepan Karpenko, Hillsboro, OR (US); Kathiravetpillai Sivanesan, Portland, OR (US); Maria Ramirez Loaiza, Beaverton, OR (US); Ned M. Smith, Beaverton, OR (US); Srikathyayani Srikanteswara, Portland, OR (US); Yi Zhang, Portland, OR (US)

(21) Appl. No.: 16/456,743

(22) Filed: Jun. 28, 2019

(51) Int. Cl. H04W 36/08; H04W 28/06; H04W 28/14; H04W 8/24; H04W 76/27

(52) U.S. Cl. CPC H04W 36/08; H04W 28/06; H04W 76/27; H04W 8/24; H04W 28/14

(57) ABSTRACT

To address technical problems facing producer and consumer mobility in cellular ICN/NDN networks, a technical solution includes leveraging device tracking during handover in the cellular system to optimize cache replacement and route updates during handover. This solution also improves performance by advance caching and route update during mobility handling, which reduces or eliminates interest packet flooding and latency for upcoming potential content request and retrieval. This solution also improves performance by operating based on the observed popularity of the content, and based on the mobility patterns of the consumer and producer.

### TECHNICAL FIELD

Embodiments described herein generally relate to processing of data in an information centric network.

### BACKGROUND

Information-centric networking (ICN) is a networking platform that transitions from a host-centric content delivery model and to an information-centric model for content delivery. The end-to-end connectivity of modern computer networks allows for delivery of information that is independent of location, application, storage, and transportation means. Content is requested by a consumer device by submitting an interest packet that provides the information needed (e.g., a name, identifier, category, etc.) to retrieve content. In response, a node containing the content (e.g., a producer node, cache node, etc.) returns a data packet including the content. This reduces the reliance on specific hosts to provide content to a requester and allows data to be propagated throughout the ICN to nodes that may most efficiently delivery the content to consumer nodes.

A named data networking (NDN) is an example of an ICN network in which data is retrieved based on named data. NDN, as specified in the NDN technical report DND-0001, is a networking architecture that enables communications by named secured data at the network layer. By aligning the network services with application needs, NDN may offer advantages over host-centric networks such as, for example, stronger security and trustworthiness, enhanced network usability, enhanced scalability, and increased resiliency in network communication. NDN is especially suitable for emerging network environments such as edge computing, Internet of Things (IoT), and other data intensive distributed networks.

An ICN/NDN may be used to facilitate data transmission between a consumer (e.g., end user) and a producer (e.g., content provider). ICN/NDN supports consumer mobility by design but lacks support for producer mobility. Native consumer mobility support may rely on interest retransmissions to recover from various adverse network events. However, this solution is not efficient in cellular systems, particularly when a producer or consumer is handed over to another base station (BS) or Evolved Node B (eNB). This may result in interest retransmissions to find the new route during the convergence time, where the convergence time includes time needed by the network to update the routing tables. What is needed is an improvement in producer and consumer mobility for cellular ICN/NDN networks.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIGS. 1A-1B are block diagrams of NDN handover routing system, according to an embodiment.

FIGS. 2A-2B are NDN caching and route updating flow diagrams, according to an embodiment.

FIG. 3 is a block diagram of a popularity score calculation, according to an embodiment.

FIGS. 4A-4B are a block diagrams of a producer mobility handover, according to an embodiment.

FIGS. 5A-5B are a block diagrams of a consumer mobility handover, according to an embodiment.

FIG. 6 is a block diagram of a user plane protocol stack, according to an embodiment.

FIG. 7 is a flow diagram of ICN packet flow, according to an embodiment.

FIG. 8 is a block diagram of a system architecture, according to an embodiment.

FIG. 9 is a flow diagram of an address exchange, according to an embodiment.

FIG. 10 is a block diagram of a network architecture, according to an embodiment.

FIG. 11 is a block diagram of a framework gateway, according to an embodiment.

FIG. 12 is a block diagram of a wireless multi-hop network, according to an embodiment.

FIG. 13 is a block diagram of a multi-finger beam network, according to an embodiment.

FIG. 14 is a block diagram of a multicasting network, according to an embodiment.

FIG. 15 is an example of a method for network function execution, according to an embodiment.

FIG. 16 illustrates an example ICN, according to an embodiment.

FIG. 17 illustrates a block diagram of an example machine upon which any one or more of the techniques discussed herein may perform.

### DETAILED DESCRIPTION

To address technical problems facing producer and consumer mobility in cellular ICN/NDN networks, a technical solution includes leveraging device tracking during handover in the cellular system to optimize cache replacement and route updates during handover. Because user equipment (UE) is tracked in cellular system during handover, a source eNB has knowledge of the next point of attachment (e.g., a target eNB) for the UE. The technical solution includes updating a new route in advance for future interest packet and content delivery during a producer or consumer handover by coordination between the source eNB and the target eNB. When the content associated with producer or consumer under handover is relatively popular content, the BS or eNB may store or retrieve the content from cache before or after the handover detection. This solution also improves performance by advance caching and route update during mobility handling, which reduces or eliminates interest packet flooding and latency for upcoming potential content request and retrieval. This solution also improves performance by operating based on the observed popularity of the content, and based on the mobility patterns of the consumer and producer.

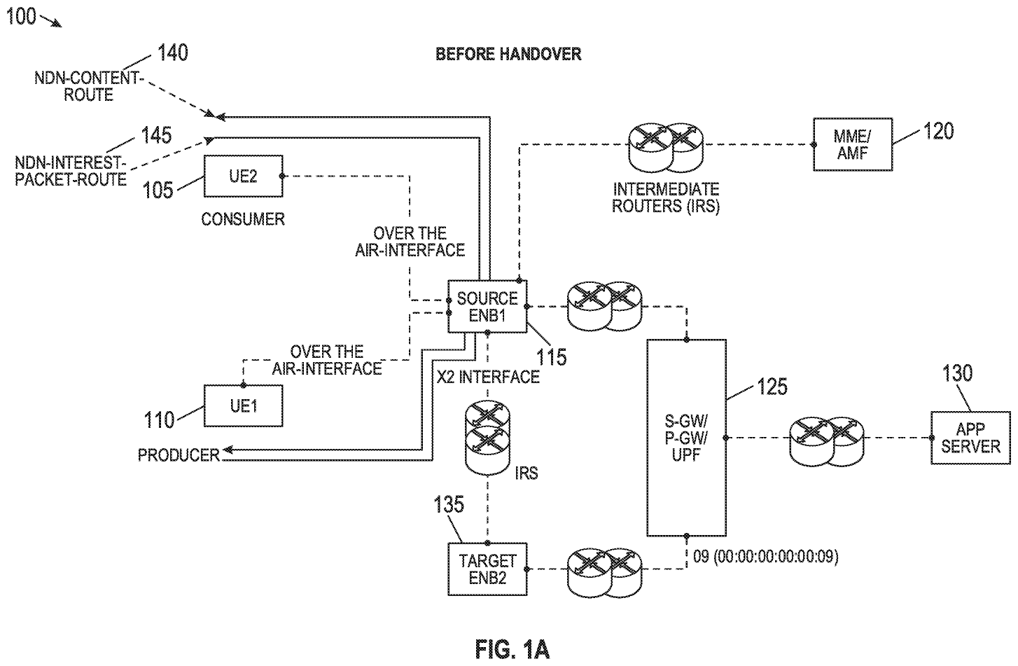

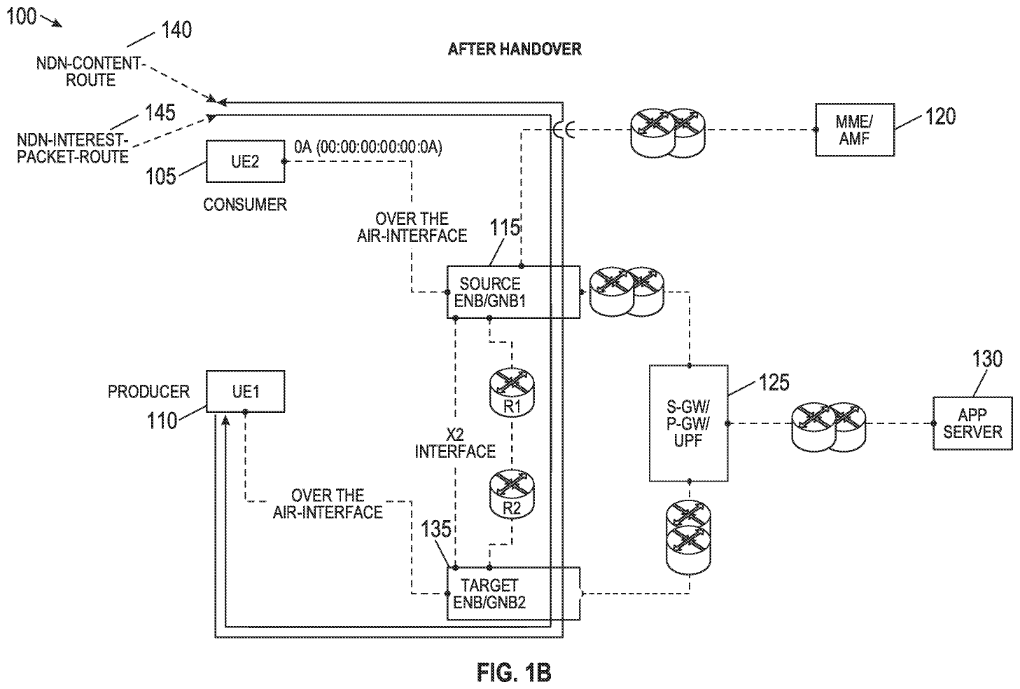

FIGS. 1A-1B are block diagrams of NDN handover routing system 100, according to an embodiment. In particular, FIG. 1A shows NDN-Content-Route and NDN-Interest-Packet-Route producer mobility before a handover, and FIG. 1B shows the corresponding configuration after a handover. This may be applied to configurations where the consumer and producer are in the same eNB, and where the producer or consumer moves to another eNB. When a producer or consumer moves to a new BS or eNB, the BS (e.g., source BS in case of producer mobility, target BS in case of consumer mobility) keeps a content copy (e.g., cache) or update route info during handover, which may be used to direct interest packet to the producer after handover. Caching and predictive route updates reduce or eliminate new route search upon interest packet arrival for a given content item after handover, thereby reducing or eliminating content delivery delay and interest packet flooding.

In an example shown in FIG. 1A, the consumer 105 and producer 110 may be in the same eNB when the producer moves to another eNB. FIG. 1A shows an NDN-content route 140 and an NDN-interest route 145 between the consumer 105 and the producer 110 through source eNB 115. Source eNB 115 may collect interest pattern data based on the contents. The source eNB 115 may generate a predicted future interest pattern based on historic data, location, and other information. The predicted future interest pattern may be generated periodically or in response to detection of a handover situation. A popularity score may be generated based on predicted interest pattern for the contents. Details of popularity score generation is provided further below. The source eNB 115 may cache most popular content (e.g., first level popular content) before handover. When a producer handover is expected, the source eNB 115 may cache second level popular content.

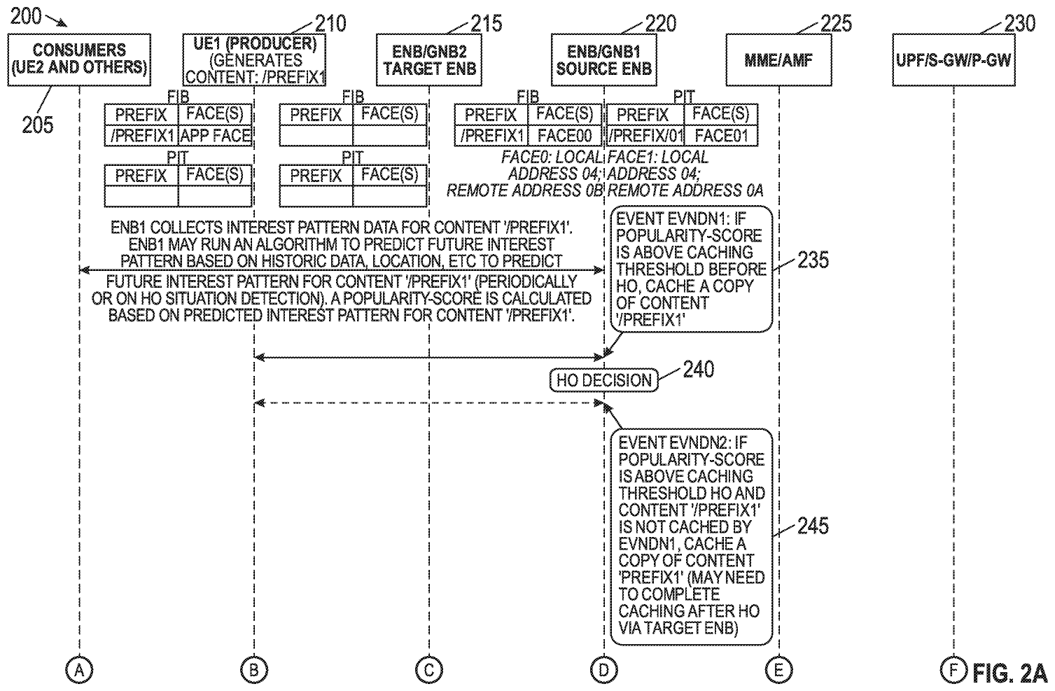

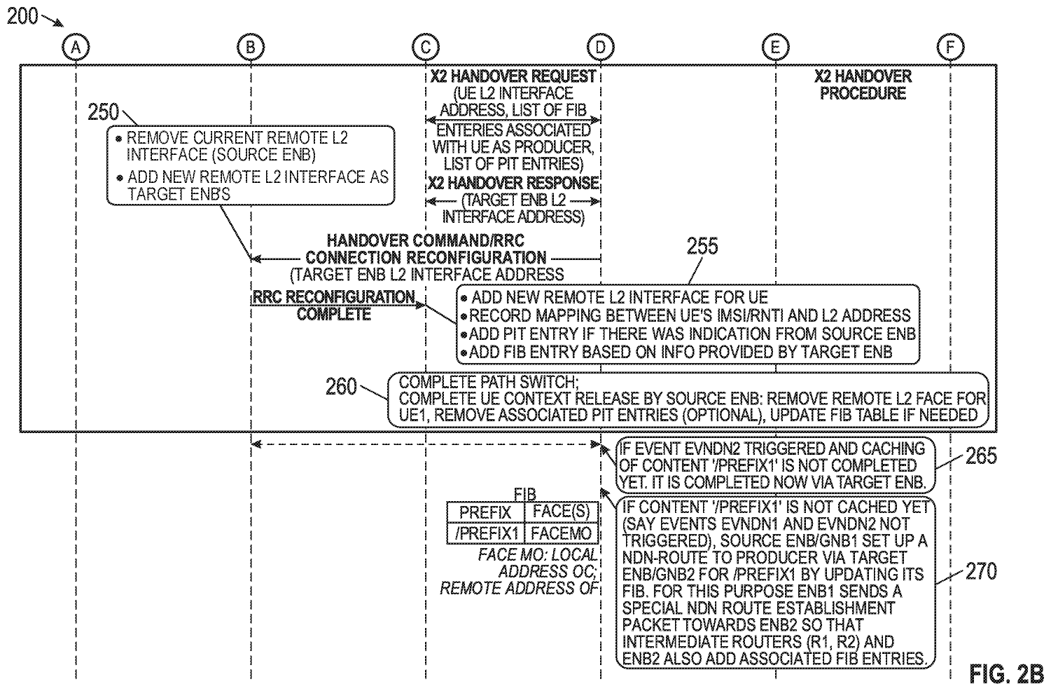

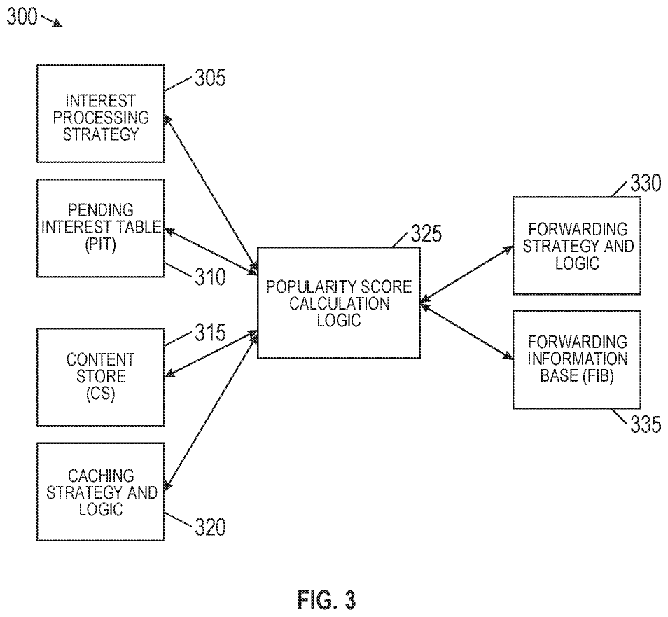

As shown in FIG. 1B, the NDN-content route 140 and an NDN-interest route 145 is updated route through both the source eNB 115 and the target eNB 135. Third level popular content may be cached using the route shown in FIG. 1B. For the least popular content, an eNB may not cache or update new routes during handover. For such content, the new route may be searched after an interest packet is received by an eNB. A new route, such as a NDN content route or an NDN interest packet route, may be established during handover for popular content as described with respect to FIGS. 2A-3.

FIGS. 2A-2B are NDN caching and route updating flow diagrams 200, according to an embodiment. In particular, FIGS. 2A-2B show an example flow of eNB interest packet pattern collection. As shown in flow diagrams 200, the result depends on the popularity of the content. For example, popular content may be cached before, during, or after handover, or a new route may be generated for content of relatively lower popularity.

In an example shown in FIG. 2A, the consumer 205 and the producer 210 may be in the same source eNB 220, and one or more consumers 205 may move to a target eNB 215. The source eNB 220 may collect interest pattern data for contents. The source eNB 220 may generate a predicted future interest pattern based on historic data, location, and other information, The predicted future interest pattern may be generated periodically or in response to detection of a. handover situation.

A popularity score may be calculated based on predicted interest pattern for the contents. The popularity score for the contents may also be calculated for each active consumer separately, so that one or more content popularity scores specific to a consumer undergoing a handover may be used to improve effective caching or improve route update decisions during handover.

When the consumer 205 moves to a target eNB 215, the source eNB 220 may provide list of contents that are popular for the consumer 205 and for the producer 210 that is in the source eNB 220. In operation, the target eNB 215 may cache most first level popular contents via source eNB 220 during or right after handover. For second level popular content, the target eNB 215 may update the new route to producer 210 via the source eNB 220 after handover. For the least popular content, the target eNB 215 may not cache or update new routes during handover. For this least popular content, a new route may be searched after an interest packet is received by the target eNB 215.

This technical solution may be applied in various other network configurations. For example, a consumer may send out an interest packet, and the base station may have a corresponding entry in a pending interest table (PIT). Before the interest is satisfied, the consumer may move to a new base station. The original base station may then automatically update its PIT entry to forward the data packet to the new base station. The base station may also add the information about the device that requested the information so that the data packet is automatically forwarded to the right consumer.

In another example, the consumer 205 and the producer 210 may be in the same source eNB 220, and the producer 210 may move to radio resource control (RRC) idle mode (e.g., inactive mode). When a producer 210 enters an idle mode, it may increase the time needed to reach the producer, which increases the delay for content delivery. Additionally, significant air-interface signaling overhead may occur due to frequent idle-to-connected transitions, such as when the producer 210 has popular content. In idle mode, producer 210 may move to new BS without informing the current BS, which may use a new interest packet forwarding route.

The likelihood of the producer 210 undergoing a transition to or from idle mode may be determined and used to address these issues facing these transitions. In an example, a learning-based algorithm may be used to predict the probability of a producer 210 moving to new BS within a predetermined time. This transition probability may be referred to as a “Producer-Moving-Out-Probability,” and may be used to indicate the likelihood that a producer 210 in idle mode may camp on another BS. The popularity score of contents may be calculated, such as described further below with respect to FIG. 3.

The popularity score may be used to perform various actions before a producer 210 transitions to an idle mode. To determine the most popular content, the popularity score may be determined to be at or above a first popularity threshold. For the most popular content, the BS may either cache the content itself or identify another UE in the cell to cache the content. To determine the second most popular content, the popularity score may be determined to be less than the first popularity threshold and at or above a second popularity threshold. For the second most popular content, the BS may coordinate with the network to configure a shorter paging cycle to the producer 210, such as by coordinating with the mobile management entity (MME) or with the access and mobility management function (AMF). For a producer 210 with a relatively higher Producer-Moving-Out-Probability, second most popular content may also be cached at BS itself or one or more UE selected by BS. To determine the least popular content, the popularity score may be determined to be less than the second popularity threshold. For the least popular content, a regular paging cycle may be configured or a proximity communication may be used. For example, a proximity communication (e.g., 3GPP Mode 2 or 4) may be used by consumer 205 and producer 210 to retrieve the content while producer 210 remains in RRC idle mode.

During the process of moving to idle mode, the BS may instruct the producer 210 to enable a proximity communication to deliver the content. The BS may inform the same to a potential consumer 205, either in advance or in response to receiving an interest packet from the consumer 205. A producer 210 may respond to receiving a page by indicating “interest packer received at BS X for a content,” the producer 210 may transition from idle mode to connected mode. When the producer 210 identifies that it has moved to a new BS while in idle mode, it may send a message to the new BS commanding it to inform the previous BS about the location of the new BS. In response to receiving the location, the previous BS may then establish a new interest packet route to producer 210 via current BS.

FIG. 3 is a block diagram of a popularity score calculation 300, according to an embodiment. The popularity score may be used to decide whether to store content, update the route, or trigger any of the mechanisms described above. The popularity score may be tied to the content, consumer, or the producer. In an example, any content produced by a certain producer might be popular. In another example, a specific content produced at a specific time or location might be popular, such as an image captured of a famous landmark. The popularity may be determined as a function of both the producer and the time or location of content produced, such as all of the content of a famous blogger who is currently traveling might be determined to be popular. When one or more consumers are moving to a new BS, it may be more important to calculate popularity of the content for these consumers, than the popularity of the content itself.

The popularity score calculation logic 325 may include multiple learning algorithms used to capture these various configurations. In an embodiment, a first learning algorithm may predict whether the popularity is determined based on the producer or the content, and a second learning algorithm may determine a popularity score that depends on the output of the first learning algorithm. In this example, the popularity score may be determined overall or for a specific set of consumers under consideration.

The first learning algorithm may include “f_1 ( ),” a binary function that predicts whether the popularity is determined based on the producer or the content. The function f_1 ( ) may include a deterministic simple function, or it may include a neural network that may be trained offline with one or more inputs. The inputs to the deterministic or neural network function may include the number of interests generated, time stamp of the interests, history of other interests requested from the same producer, popularity score of the previous interests from the producer, location, popularity score of interests in the current location, or other inputs.

In an embodiment, the second learning algorithm may include “f_2 ( ),” a function that predicts a popularity score of the producer. This f_2 ( ) may be activated in response to f_1 ( ) predicting that the producer is popular. The inputs for this function may include a relevant subset of the features described above, such as a number of interests generated, time stamp of the interests, history of other interests requested from the same producer, popularity score of the previous interests from the producer, or other inputs.

In an embodiment, the second learning algorithm may include “f_3_1 ( )” or “f_3_2 ( ),” which are functions that predict the popularity score of the content for all consumers and a subset of consumers, respectively. One of these two functions may activated in response to f_1 ( ) predicting that the content is popular. The inputs of function f_3_1 may include a relevant subset of input features, such as number of interests generated by all consumers, time stamp of the interests, location and popularity score of interests in the current location, and other inputs. The inputs of function f_3_2 may include a relevant subset of input features, such as number of interests generated by specific one or more consumers under consideration, time stamp of the interests, location and popularity score of interests in the current location, and other inputs.

The functions within the popularity score calculation logic 325 may be modified based on how the content producer is classified. In a first producer classification example, a producer may include a content store that may be caching content from another CS. In a second producer classification example, a producer may include a content author, which might be indicated by meta data associated with the content. In the case of the first producer classification example, the popularity score may include a function of CS utilization and may provide information regarding when to add or remove capacity based on the utilization. In the case of the second producer classification example, the content metadata may be useful in determining an interest. For example, the interest request may not be for content named “/myfile,” and instead may be for metadata that potentially describes many files (e.g., “/author_name”). To address content popularity score calculations, the content being served may satisfy multiple scores, including a score for the content itself, and including scores for each metadata item associated with the content. The threshold computation may determine an aggregate score for the content based on all of the popularity scores. For example, if content author metadata scores high, then “/myfile1” and “/myfile2” scores each may be low but remain in a CS cache because of the “/author_name” metadata score.

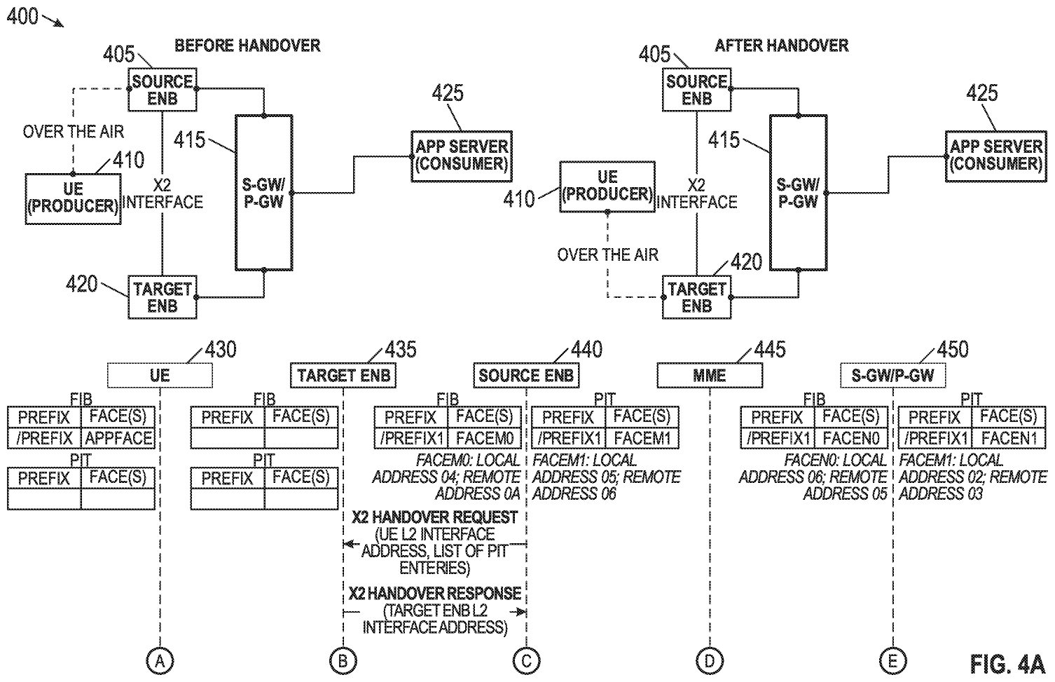

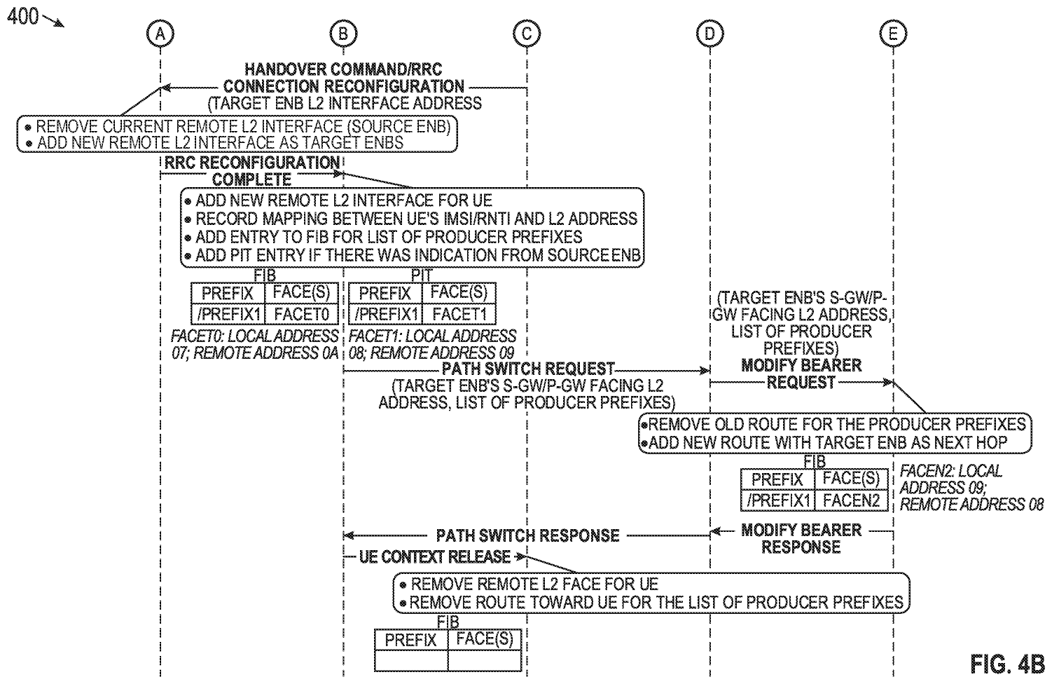

FIGS. 4A-4B are a block diagrams of a producer mobility handover 400, according to an embodiment. Handover 400 shows major steps major steps, core network signaling, and path switch procedures for a producer mobility handover in an ICN cellular system. Before handover, the producer UE 410 may communicate via over-the-air (OTA) to the source eNB 405. After handover, the producer UE 410 may communicate via OTA to the target eNB 420. Both before and after handover, the source eNB 405 and target eNB 420 may communicate with the consumer app server 425 via gateway 415, such as using a single hop path. Gateway 415 may include a serving gateway (S-GW) or a PDN gateway (P-GW). Handover 400 also shows corresponding ICN table updates.

As shown in FIG. 4B, to complete RRC reconfiguration between the UE 430 and the target eNB 435, a new remote L2 interface is added for UE 430, a mapping is recorded between UE 430 IMSI/RNTI and L2 address, an entry is added to FIB for list of producer prefixes, and a PIT entry is added if there was indication from source eNB. Also, as shown in FIG. 4B, to modify a bearer request between MME 445 and the gateway 450, an old route is removed for the producer prefixes, and a new route is added with target eNB 435 as next hop.

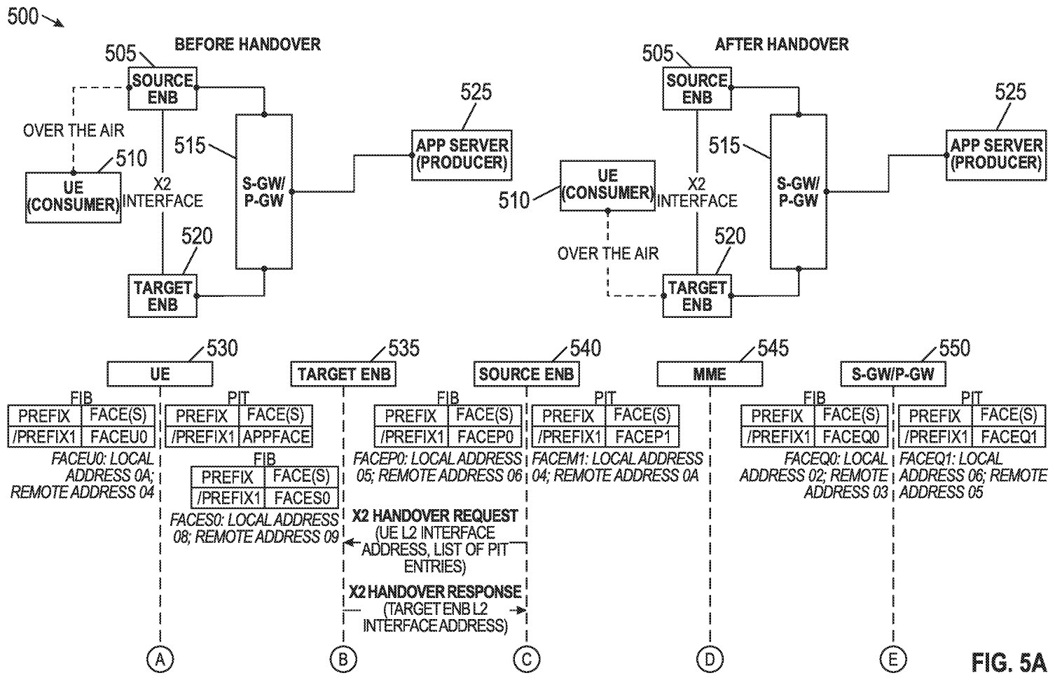

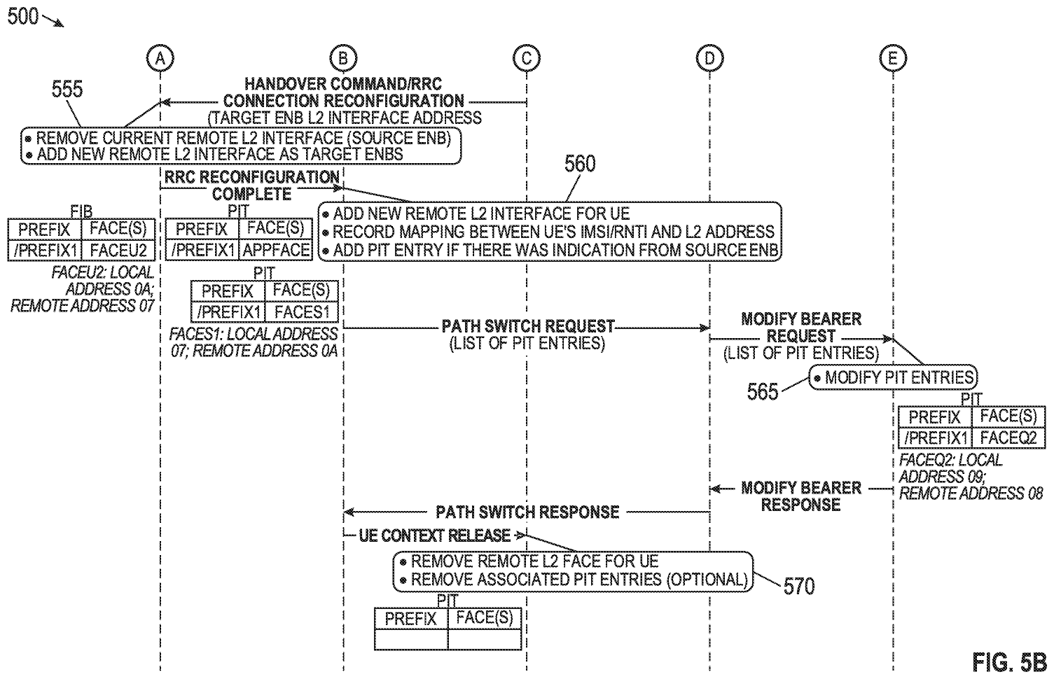

FIGS. 5A-5B are a block diagrams of a consumer mobility handover 500, according to an embodiment. Handover 500 shows major steps, core network signaling, and path switch procedures for a consumer mobility handover 500 in an ICN cellular system. Before handover, the consumer UE 510 may communicate via over-the-air (OTA) to the source eNB 505. After handover, the consumer UE 510 may communicate via OTA to the target eNB 520, Both before and after handover, the source eNB 505 and target eNB 520 may communicate with the producer app server 525 via gateway 515, such as using a single hop path. Gateway 515 may include a serving gateway (S-GW) or a PDN gateway (P-GW). Handover 400 also shows corresponding ICN table updates.

As shown in FIG. 5B, to complete RRC reconfiguration between the UE 530 and the target eNB 535, a new remote L2 interface is added for UE 530, a mapping is recorded between UP, 530 IMSI/RNTI and L2 address, and a PIT entry is added if there was indication from source eNB. Also, as shown in FIG. 5B, to modify a bearer request between MME 545 and the gateway 550, the PIT entries are modified.

The technical solutions shown in FIGS. 1-5B provide systems and methods for improving producer and consumer mobility in the cellular ICN/NDN network using the existing device tracking feature of the cellular system during handover. These technical solutions improve or maximize the efficiency of cache placement and replacement and new route updates by coordination between source and target eNBs.

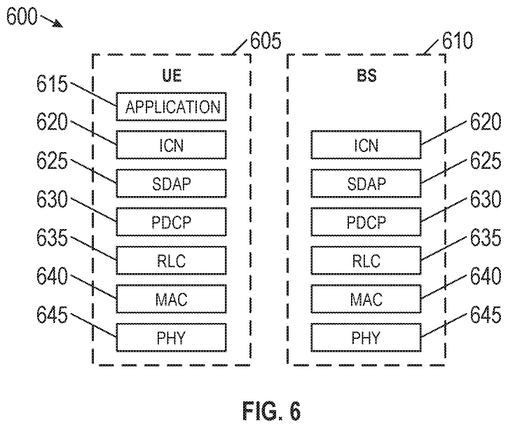

FIG. 6 is a block diagram of a user plane protocol stack 600, according to an embodiment. Protocol stack 600 includes user equipment (UE) 605 and base station (BS) 620. As used herein, the BS 620 may also be referred to as eNB in the context of 4G network architecture or 5G eNB (gNB) in the context of 5G network architecture. The UE 605 may include general mobile devices, internet of things (IoT) devices, vehicles, or other devices. The UE 605 may act as the content producer or content consumer. Regardless of whether the LE 605 is a content producer or consumer, an air interface transmission between UE 605 and BS 610 may form the first hop or the last hop of an ICN packet (e.g., interest packet, data packet) transmission. In an embodiment, the control plane follows current 4G/5G design, the user plane data delivery is ICN-based transmission, and each node in the network is ICN capable and is able to intercept the received ICN packet.

Technical solutions described herein improve the efficiency of ICN packet transmissions in cellular networks. These solutions include a modification to using a plane option with a previously configured data radio bearers (DRB) for all network-layer (e.g., ICN-layer) interest packets or data packets. Instead, the UE 605 or BS 610 may select the transmission options (e.g., via control plane, via user plane) according to ICN packet size, radio resource control (RRC) state of the UE 605, capability of the LT 605 or BS 610, and other info. To support these technical solutions, the BS 610 is made aware of ICN packet transmission if ICN functionality is enabled at BS 610, and the protocol stack at the BS 610 may be modified. The ICN packet transmission in air interface and radio access network may be better supported with added flexibility and efficiency under different scenarios, variable ICN packet size, various RRC states of the UE 605, DL or UL transmission, capability of the UE 605 or BS 610, or other scenarios.

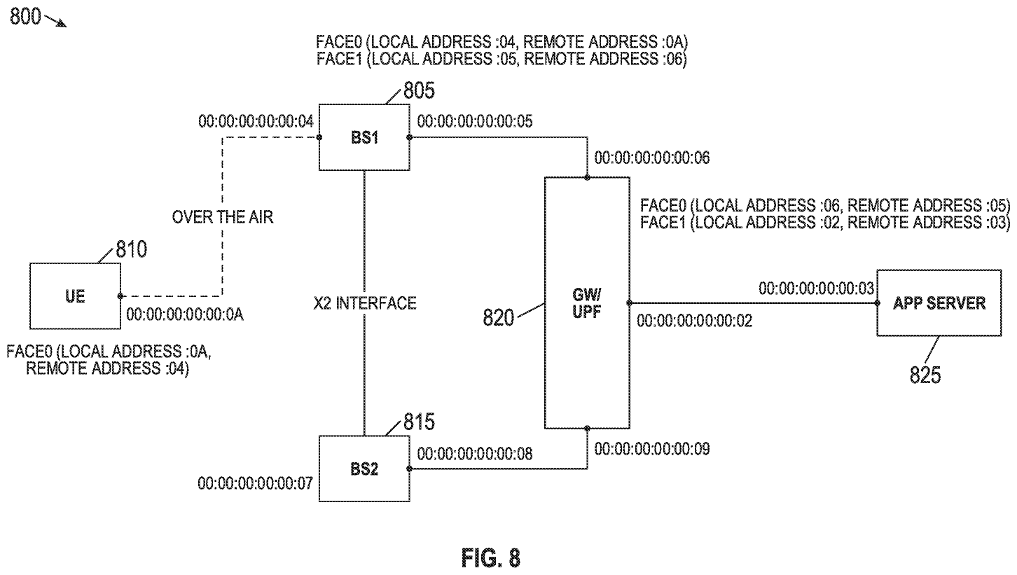

Technical solutions described herein improve efficiency of transmission of ICN packets in cellular network while reducing adverse effects to the existing architecture. These solutions also provide transmission options for interest packet and data packet on air interface, such as providing transmission options for the first hop and last hop transmission of ICN packets on the air interface. These solutions also provide an L2 interface address exchange. The use of a “face” is described below with respect to FIG. 8, and includes local L2 interface address and remote L2 interface address, which are used to indicate where the ICN packet is forwarded from or forwarded to. As discussed herein, network entities (e.g., UE, BS, MME/AMF) may be assigned at least one local L2 interface addresses for different faces. These solutions also provide improvements to the L2 interface addresses exchange between UE 605 and BS 610. PDCP 630 layer may perform the compression on the naming part to reduce usage of air interface resources.

As shown in FIG. 6, user plane protocol stack 600 includes a protocol of air interface with support of ICN (e.g., based on 5G). Considering the per-hop transmission feature of ICN, the technical solutions described herein decouple the transmission in air interface and RAN/Core Network and provide more freedom to the BS 610 and UE 605 to select transmission options, e.g., via control plane or user plane based upon ICN packet size, UE's RRC state, UE/BS capability and other information. As a result, it is not necessary for air interface to follow the same transmission options that are used in RAN and Core Network.

The UE 605 and BS 610 consider various factors in deciding whether to send an ICN packet on the control plane or user plane. These factors may include the size of the packet to be sent. For example, interest packets are generally smaller in size than data packets, making it more efficient to send a smaller interest packet via control plane. Another factor is the capability of the UE 605 and BS 610. Support of ICN packet on control plane or data plane may be configurable on the UE 605 and BS 610. This may be pre-configured or determined in each ICN packet transmission. The UE 605 and BS 610 may retain overall capacity statistics describing usage of control plane compared to the user plane.

In an embodiment, the UE 605 may be in RRC idle mode. The UE 605 may use different configurations to send interest packets and data packets through the control plane or data plane to the BS 610 where the UE 605 is camped. For example, the UE 605 may send packets via a control plane. The use of the control plane may reduce latency by avoiding waiting for completion of the establishment process when UE 605 is in RRC idle mode and wants to send a short interest packet or short data packet. The ICN packet may be carried in a UL RRC message. A new IE may be defined and used to carry the ICN packet. Once this IE is created and presents itself, the BS 610 knows that ICN data is carried and it will interpret the content. In another example, the ICN packet may be carried in NAS message. The ICN packet may be encapsulated in a NAS message, however this NAS message may no longer be transparent to the BS 610. The BS 610 may be aware of the ICN packet and be able to de-capsulate it. The BS 610 may not forward it to AMF/MME. A notification may be carried in the RRC message to indicate the BS 610 is to read the NAS PDU. In an example, the UE 605 may send packets via the user plane, such as when the packet size is large and may not fit for transmission on control plane. The DRB configuration may be triggered at the BS 610 once the BS 610 receives the RRC Connection Setup Complete message, instead of being triggered by core network (e.g., receiving the S1/N2 Request from MME/AMF). A notification (e.g., UE 605 has ICN capability, UE 605 wants to send ICN packet on data plane) may be set in the UL RRC message to indicate the BS 610 is to trigger the DRB setup. In the event that the UE 605 sends an interest packet via control plane message to BS 610 and the BS 610 happens to have the content in its content cache, DRB setup may be triggered by BS 610 naturally if the BS 610 decides to transmit the data packet on user plane.

In an embodiment, the UE 605 may receive interest packets and data packets via the control plane or data plane. In case of RRC idle mode and ICN interest packet reception, the UE 605 is known in Tracking Area (TA) level. The AMF may send a paging request to each BS 610 in the TA, and the core network will keep a record of that translation from name space to device ID. If network is unaware of where the producer is, considering the small size of interest packet, the ICN interest packet may be carried in the paging message. For group-based interest packet broadcast, the interest packet may be broadcast for a group of ICN-capable UEs in MEMS who subscribe to ICN interest. In response to receiving the interest packet, the UE 605 may check if it has the requested data and trigger the procedure described above, including the UE 605 using various configurations to send interest packets and data packets through control plane or data plane to the BS 610 where the UE 605 is camped. If the size of interest packet exceeds the threshold and cannot be fit into control plane message, the UE 605 may ask the BS 610 to setup DRB for the DL interest packet transmission in response to receiving the paging message. In case of RRC idle mode and DUN data packet reception, the MME/AMF may send paging request to each the BS 610 in the TA, the UE 605 may go into RRC-Connected mode, and the location may be known to MME/AMF. However, this scenario may be rare, as it is more likely that the UE 605 keeps in RRC-Connected mode until it receives a data packet.

In an embodiment, the UE 605 may be in RRC-Inactive mode. The UE 605 may send interest packets and data packets through control plane or data plane. The UE 605 and the BS 610 in RRC-Inactive mode may maintain configurations obtained in RRC-Connected (e.g., AS context, security, and radio bearers) so that following the random access, the UE 605 may resume its previous configurations without much delay by using RRC Connection Resume procedure. Similar to scenarios described above, ICN packets may be carried via either control plane or user plane. The user plane may be preferred to the control plane because DRB may be resumed quickly. During an RRC connection resume procedure, the BS 610 may be aware that this connection is resumed for ICN packet, it may determine whether it is necessary to resume the S1/S5 or N3 bearer. The BS 610 may intercept the ICN data to determine where to forward it. One indicator is sent from the UE 605 to the BS 610 during RRC resume procedure to indicate the RRC is resuming for ICN packet delivery. Upon receipt of the indication, the BS 610 knows that the DRB is resumed for UL ICN, and it will refrain from resuming S1/S5 bearer or N3 session. In case the UE 605 sends interest packet via control plane message to the BS 610 and the BS 610 happens to have the content in its content store, DRB resume is triggered by the BS 610 naturally if the BS 610 decides to transmit the data packet on user plane.

In an embodiment, the UE 605 may receive interest packet and data packet via control plane or data plane. In case of RRC-Inactive mode, the UE 605 may be reachable at the RAN level. A RAN paging trigger event may occur for the incoming DL data or signaling from Core network. RAN paging may be triggered either only in the cells controlled by the last serving the BS 610 or by means of X2/Xn RAN Paging in cells controlled by other the BS 610, configured to the UE 605 in the RAN-based Notification Area (RNA). RAN may be configured to support ICN packet handover from the last serving the BS 610 to the current the BS 610 where the UE 605 camps. Upon receipt of RAN paging, the UE 605 may resume the RRC connection. The DL ICN packet may be carried in DL via control plane messages or via user plane by resuming the DRB.

In an embodiment, the UE 605 may be in RRC-Connected mode. The UE 605 may send interest packets and data packets via control plane or data plane. When the UE 605 is in RRC-Connected mode, an ICN packet may be piggybacked in RRC message if DRB is not yet configured. If the DRB is already available between the UE 605 and the serving the BS 610, the ICN packet may be carried in the DRB. In this case, the BS 610 may interpret the data rather than putting the data in S1/N3 session blindly. The UE 605 may receive interest packets and data packets via the control plane or data plane. The BS 610 may be second to last node to receive the ICN packet. The BS 610 may forward the ICN packet through control plane or user plane, though a user plane is preferred in this case.

The protocol stack 600 may be used to implement ICN in cellular networks, such as LTE Core Networks and 5GC networks. In cellular 3GPP 4G/5G architecture, an evolved packet system (EPS) bearer or protocol data unit (PDU) session may be configured between a packet gateway (PGW) or user plane function (UPF) and eNB or 5G evolved node B (gNB) in order to transmit the application layer packets between the UE 605 and a gateway. A Data Radio Bearer (DRB) may be configured in the air interface to map the S1/S5 bearer or N3 PDU session. 3GPP also supports transmission of small data through a non-access stratum (NAS) message between the UE 605 and MME, which is further transmitted in the path of MME-SGW-PGW (e.g., control plane consumer IoT (CIoT) EPS optimization).

The transmission via air interface and the transmission in the RAN/Core network may coupled closely because it is an end-to-end transmission. In particular, an EPS bearer/PDU session between the UE 605 and GW/UPF may be configured before the data transmissions begin. Additionally, DRB setup may be part of an EPS bearer/PDU session establishment procedure and may be triggered by an S1 Request after UL bearer on the S1/S5 interface is setup successfully or may be triggered by an N2 Request after PDU session on an N3 interface is setup successfully in 5G.

The network function may aid in detectability. For example, these technical solutions are related to 3GPP, so an examination of TS specs related to network function series on incorporating ICN functionality within the cellular core network (e.g., 23 series, 24 series) may be used to identify usage of the technical solutions described herein. Similarly, specification section 38 relating to incorporating ICN functionality on air interface may be used to identify usage of the technical solutions described herein.

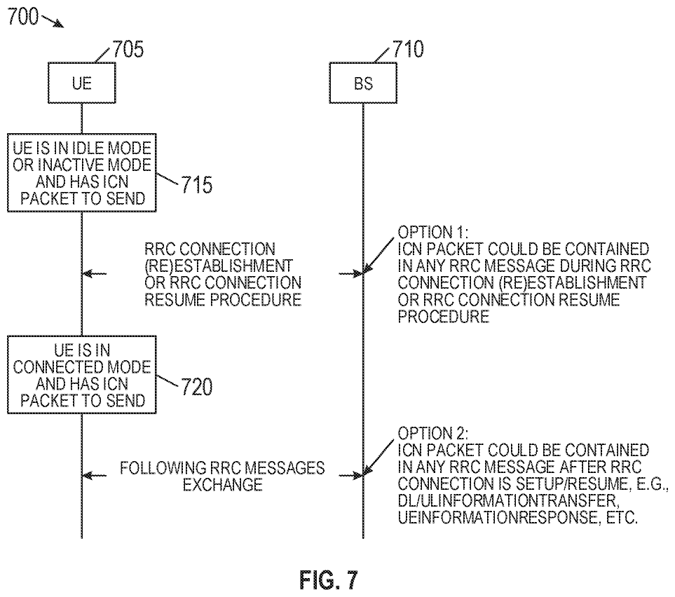

FIG. 7 is a flow diagram of ICN packet flow 700, according to an embodiment. In particular, ICN packet flow 700 shows a flow example for a mobility option (MO) ICN packet over RRC. When the UE is in RRC idle mode or RR-Inactivity mode 715, ICN packet IE may be contained in any UL RRC message during RRC Connection establishment or reestablishment or RRC Connection Resume procedure. After UE is in RRC-Connected mode 720, ICN packet 1E may be contained in any UL RRC message, (e.g., ULInformationTransfer, UEInformationResponse. The ICN interest or data packet from the BS 710 to the UE 705 may be contained in any DL RRC message (e.g., DLInformationTransfer, RRCConnectionReconfiguration).

A new RRC Information Element may be used, such as shown in Table 1:

TABLE 1
RRC Information Element

| ICNPacket-rxx ::= | SEQUENCE { | |
|---|---|---|
| ICN-Packet-Carried | ENUMERATED {RRC, NAS, spare} | |
| ICN-Container-rxx | OCTET STRING | OPTIONAL |

...
}

The ICN-Packet-Carried may have two values {RRC, NAS} to indicate the ICN is carried in RRC directly or in NAS PDU. If the ICN packet is sent through RRC message directly, the ICN-Packet-Carried may be set to RRC. The BS may know the ICN packet is carried and may interpret the content that is contained in ICN-Container-rxx. If the ICN packet is sent in NAS PDU that is piggybacked in RRC messages, the ICN-Packet-Carried may be set to NAS. The BS may know the ICN packet is carried and may interpret the content that is contained in DedicatedInfoNAS.

FIG. 8 is a block diagram of a system architecture 800, according to an embodiment. System architecture 800 illustrates a mapping between an L2 interface address and faces. As used herein, the “face” includes local L2 interface address and remote L2 interface address and is used in PIT and FIB tables to indicate where the ICN packet is forwarded from or to. Each network entity (e.g., UE, eNB/gNB, MME/AMF) may have different L2 interface addresses that are mapped to different faces.

System architecture 800 shows an example of face configuration for each network node. UE 810 may use Face( ) (local address: 0a, remote address: 04) to indicate the connection with BS1 805. BS1 805 may use Face1 (local address: 04, remote address: 0a) to indicate the connection with UE 810, and use Face2 (local address: 05, remote address: 06) to indicate the connection with GW/UPF 820. However, it is not necessary for cellular network to define a new L2 interface address for ICN. Other identities, such as BS ID (e.g., ECGI) or UE ID C-RNTI), may be reused as alternative options.

In an embodiment, the L2 interface address may be exchanged between UE 810 and BS 805 when UE from idle to connected mode. There may be three alternatives for UE 810 and BS 805 to exchange their L2 interface addresses. In a first example, the remote L2 interface address may be exchanged via messages, such as RRC or NAS messages. In this first example, the BS L2 interface address for each UE may be configured as UE-specific ones or common to all UEs which are connecting to this BS. In a second example, the UE gets BS's L2 interface address through broadcast message and UE feedback its L2 interface address through UL message. In this second example, the BS L2 interface address may be common to all UEs that are connecting to this BS. In a third example, the UE may calculate the BS L2 interface address based on Physical Cell ID (PCI) or Global Cell ID (ECU). Similarly, the BS may calculate UE L2 interface address based on UE's ID, e.g., C-RNTI, S-TMSI or random value that is sent in the RRC Connection Request message. The algorithm may be preconfigured in ME or configured during an authentication or authorization procedure.

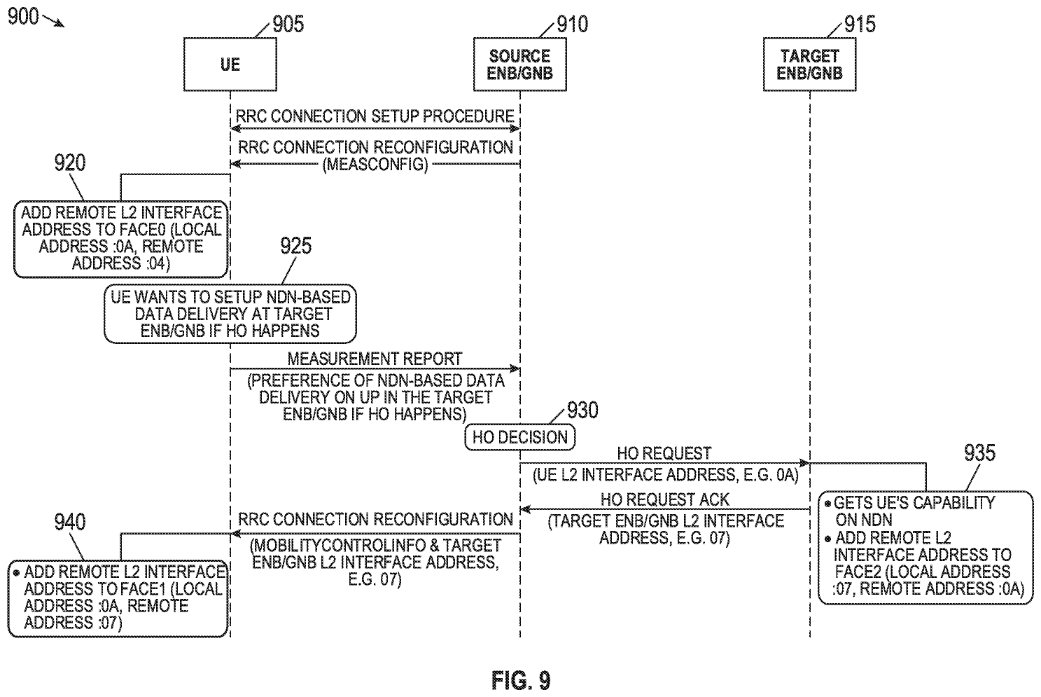

FIG. 9 is a flow diagram of an address exchange 900, according to an embodiment. In particular, address exchange 900 shows an L2 interface address exchange 900 between a UE 905 and a target eNB/gNB 915 during an X2 handover. The air interface messages and S1/X2 (4G) or Xn/NG (5G) interface messages may be used to exchange the L2 interface address between UE 905 and the Target BS 915.

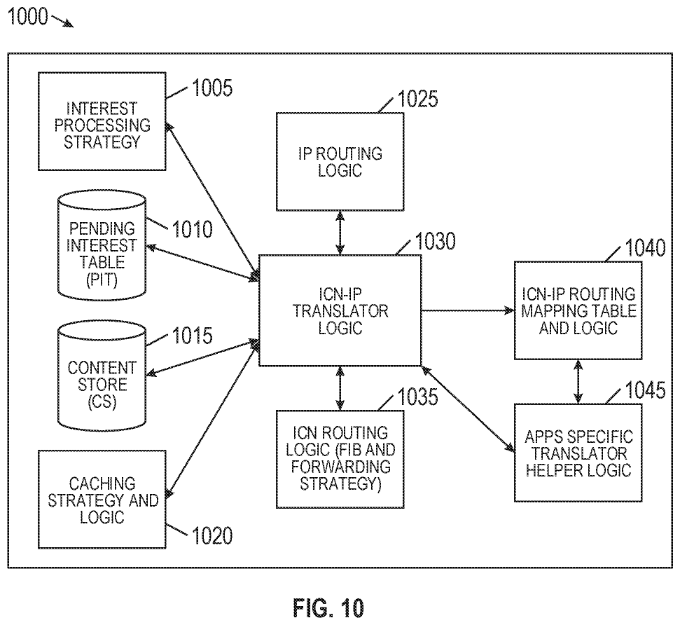

FIG. 10 is a block diagram of a network architecture 1000, according to an embodiment. In particular, network architecture 1000 shows various entities and logics at edge gateway or user plane function (UPF), which may be used as proxy or orchestrator for ICN-IP translation. The characteristics of ICN may be leveraged to provide a candidate network layer protocol for wireless and cellular networks. In addition to IP, ICN provides a different new network layer option with additional features. The technical solutions described herein provide data type translation at an edge gateway, where a network (e.g., wireless network) may be ICN-based while the rest of the internet is not ICN-based. For Example, UPF (e.g., PSA) in 5G or packet gateway (PGW) in LTE may include capabilities to perform protocol translation from ICN to IP and from IP to ICN. These solutions leverage a combination of ICN-based data delivery within the wireless networks and IP-based data delivery outside of the network. These solutions provide ICN-IP translation, which provides solutions for network boundaries between IP and ICN networks.

The network architecture 1000 may be used in various configurations. In an embodiment, a wireless network (e.g., cellular, Wi-Fi) has ICN capability, such as where each node within the network is ICN-capable. The edge gateway (e.g., UPF in 5G may be the interconnect point between the mobile infrastructure and the Data Network (DN). An APP server may be located outside of the user network. The data delivery between the APP server and the edge gateway is IP-based. Either of the UE and APP server may function as a content producer or consumer. This may also apply to private networks with an edge gateway, where ICA is supported inside the private network and the edge gateway performs the translation.

The network architecture 1000 may be used for freely available data (e.g., Youtube, CNN, Yahoo, Wikipedia, maps) that forms a significant portion of the services, or for machine type communications. If the access is restricted, then the consumer's credentials may be collected and passed to the publisher. Additionally, if the content is encrypted per user, the encryption may reduce the benefits caching.

The network architecture 1000 may be used to connect any ICN-based network to any IP-based network, such as to provide functions performed by the gateway that connects the two networks to perform the translation from ICN to IP and from IP to ICN. Network architecture 1000 realizes ICN-based data delivery within the wireless networks and IP-based data delivery outside of the network.

The network architecture 1000 enables part of the network to be deployed as ICN with seamless operation with remaining part of non-ICN network, which may be a flexible initial deployment option of ICN network in the near future. For example, this provides technology for operator to deploy ICN based RAN/Core with seamless operation with existing IP-based data networks. Additionally, in many private networks it is possible that same or similar content is requested by multiple devices. In such situations, the content may be fetched from the server only once, as opposed to being fetched from the server each time (e.g., IP configuration). These solutions enable ICN-based wired or wireless networks to interconnect to IP-based wired or wireless networks. The network architecture 1000 may aid in detectability. For example, these technical solutions are related to 3GPP, so an examination of TS specs related to network function series on incorporating ICN functionality within the cellular core network (e.g., 23 series, 24 series) may be used to identify usage of the technical solutions described herein.

In network architecture 1000, the edge gateway may act as a proxy or orchestrator that translates ICN interest into IP request to get content from outside IP network. Similarly, if data comes from an IP network for a UE in cellular system, the edge gateway may translate the content into ICN Content or response and forward the content to the UE via ICN routing.

In an embodiment, a consumer (e.g., UE) may send an interest packet to the BS to request content or data. The BS may check if it has the content in its cache. If the BS does not have the content, the BS determines whether the content is available outside of the network. For example, the BS may determine that the requested content is “/youtube/movie/movie_name/version/” and it is available on the YouTube servers. The BS may forward the interest in the direction of the edge gateway. In the cellular network (e.g., 5G), the edge gateway is the UPF. If none of the intermediate routers on the path to gateway has the content in the content cache, the interest packet may arrive at the edge gateway of the network. When edge gateway receives the interest packet, it may determine the IP address of the targeted destination based on the requested content name. Operators may allow service providers (e.g., Google, Amazon etc.) to install their application-specific translation logic at the UPF, such as Apps Specific Translator Helper Logic 1045. This logic may help to decide how to translate between the ICN interest packet and the IP packet. The UPF may maintain an ICN-IP Routing Mapping Table 1040, Table 2 shows an example ICN-IP Routing Mapping Table 1040:

TABLE 2
ICN-IP Routing Mapping Table

| | | | |
|---|---|---|---|
| Content | Outside Producer's | Port number | Producer (temporary) |
| Prefix | IP address | (optional) | IP address |

As shown in Table 2, “Port number” is optional, and may be used to identify different applications on the APP server.

When edge gateway receives the interest packet, it may create a connected session with the desired APP server. In an embodiment, ICN-IP Translator Logic 1030 may generate IP packets that contains the request and set the source IP address to UE IP address. Here, the UE IP address may be used by UPF to identify the content prefix based on the information kept in the ICN-IP Routing Mapping Table. The UE may already have been assigned an IP address and the UPF may fetch it, such as when the UPF may obtain the UE's IP address from some severs in the operators' domain. Even if the UE has an IP address, it may choose to make an ICN-based request to reduce latency and network congestion. If the UE was not previously assigned an IP address, ICN-IP Translator Logic 1030 may assign a temporary or virtual IP address for this UE or for the requested content prefix and insert this information into ICN-IP Routing Mapping Table 1040. In this embodiment, the ICN-IP Routing Mapping Table may be updated as shown in Table 3:

TABLE 3
ICN-IP Routing Mapping Table

| | | | |
|---|---|---|---|
| Content | Outside Producer's | Port number | Requester/Consumer |
| Prefix | IP address | (optional) | (temporary) IP address |

In an embodiment, ICN-IP Translator Logic 1030 may generate IP packets that contains the request and set the source IP address to its own IP address, such as if the UPF sends the IP packets to APP server. The edge gateway may forward the generated IP packet to APP server.

Once the edge gateway receives IP packets back from APP server, then if ICN-IP Translator Logic 1030 may generate IP packets that contains the request and set the source IP address to UE IP address, the edge gateway checks the ICN-IP Routing Mapping Table 1040 to determine the requested Content Prefix based on the Destination IP address of the received IP packet. If the ICN-IP Translator Logic 1030 may generate IP packets that contains the request and set the source IP address to its own IP address, then the edge gateway relies on Apps Specific Translator Helper Logic 1045 to determine the Content Prefix by analyzing the content of the received IP packets from APP server.

Upon determining the Content Prefix, the edge gateway refers to the PIT table 1010 based on the content prefix to determine the return path. The ICN-IP Translator Logic 1030 translate the received IP packet to ICN Data Packet and sends it back by using ICN routing mechanism. Because the new packet is an ICN packet, it may be stored in any of the intermediate routers and served again if the same request comes through.

In an embodiment, a consumer may send an interest packet with a specific IP based content in the name field, which facilitates the edge gateway to translate the ICN packet to IP packet. The IP based content may be stored in the content stores along with associated the subcomponents (e.g., URIs, references) to get the subcomponents in the FIB. The data packet may also be signed by the gateway that originally requested the content from the IP network. When the intermediate router determines whether the content is in the cache or not, it determines whether all the component URIs are present or if any of them have to be retrieved separately. Once the entire content is assembled into a content package, the content package is sent back to the consumer using normal ICN routing rules. A time stamp may be applied to the data when it is received at the gateway. The consumer may request data to be more recent than a specified data time, and the data time may be indicated in the interest packet. If cached copies are later than the data time, newer data is retrieved.

In an embodiment, the UE may be the producer and the outside IP based consumer (e.g., APP server) may submit a request for content. The APP server may request content from one specific UE, or the APP server may request content without specifying from which UE the content is to be retrieved. When the APP server requests content from one specific UE, the edge gateway keeps a table on UE IP address, and the edge gateway knows where the UE is by interacting with other network entities (e.g., AMF in 5G). The UE may be not aware of this IP address, such as when the address includes a temporary or virtual IP address. The IP address may be used by an outside network to identify a UE. The outside APP server may know the UE IP address and send an IP packet to an edge gateway with the Destination IP address set to the UE IP address. When the APP server may request content without specifying from which UE the content is to be retrieved, the outside APP server may send IP packets to the edge gateway with Destination IP address set to gateway's IP address. In either configuration, the edge gateway may maintain a mapping table that indicates the Content List and the Producer IP address ID. This table may be obtained from other network entities. The edge gateway may use this mapping table and other information to determine the network location of the producer.

When the edge gateway receives the IP based request, it may extract the content prefix by analyzing the IP packets front APP server, or it may verify whether it has the content in its cache. If the server does not have the content in its cache, it may translate the IP packet to ICN packet and determine where to forward the ICN packet. If the APP server requests content from one specific UE, because the APP server already identifies which UE it wants to talk with, the edge gateway may determine the network location of the UE based on the information it gets from another network entity (e.g., AMF). Upon determination of the network location of the UE, it may forward the ICN packet and fill the PIT table accordingly. If the APP server requests content without specifying from which UE the content is to be retrieved, it checks the content list to determine from which UE it may get the content, forward the ICN interest packet, and fill the PIT table accordingly. The ICN-IP Routing Mapping Table may be updated as shown in Table 4, below:

TABLE 4
ICN-IP Routing Mapping Table

| | | | |
|---|---|---|---|
| Content | Outside Consumer's | Port number | Producer (temporary) |
| Prefix | IP address | (optional) | IP address |

Although the UE may be the original producer, the consumer will still benefit from caches within the network. The data packet may come from the original producer or from any network node or intermediate router (e.g., in the private or cellular network inside the edge gateway) where the content was cached. Once the data packet is received, the edge gateway may identify the content, route it into an IP packet, and send it to the APP server by checking ICN-IP Routing Mapping Table.

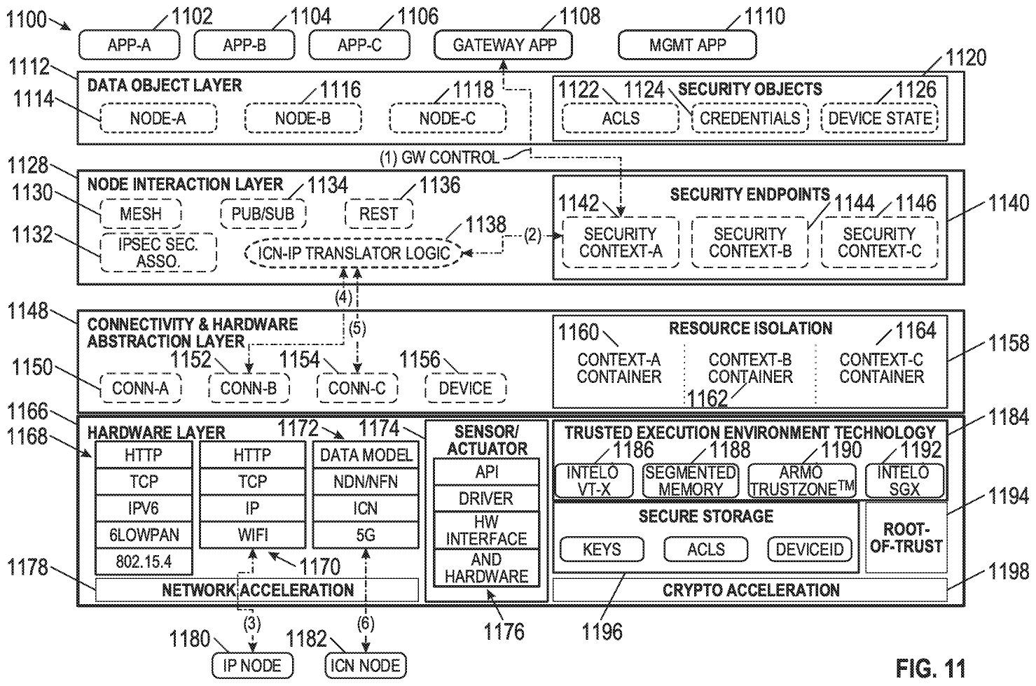

FIG. 11 is a block diagram of a framework gateway 1100, according to an embodiment. The framework gateway 1100 may be used for an IoT framework gateway, such as for interoperable ICN and IP networks. IoT and Edge networks may interoperate with a variety of brownfield IoT and Industrial IoT (fIoT) fieldbuses and communications protocols, protocols that may not be based on IP or other Internet-based protocols (e.g. TCP, UDP, HTTP). Various IoT or IIoT frameworks exist, such as Open Connectivity Foundation (OCF), Open Fog Consortium (OFC), OPC-UA, One-M2M, and others. These frameworks may address interoperability challenges. ICNs may present an additional interoperability challenge that frameworks may be effective at resolving.

As shown in FIG. 11, framework gateway 1100 is used to accommodate two or more IoT network stacks that enables a network of IP-based IoT devices and a network of ICN IoT devices to interoperate. A framework gateway application may be used to initialize gateway mapping and translation operations. A framework security context may be assigned to perform packet encryption, decryption, authentication and authorization operations according to a security mapping policy specific to the IP and ICN based networks. For example, the Framework Data Object Layer 1112 may be used to relate the ICN content structures to IP-based IoT nodes. In an example, an IP node 1180 may connect to a framework gateway to interoperate with an ICN node 1182 or content. The IP node 1180 may connect over a wireless communications channel such as WIFI 1170 and may support TCP/IP and. HTTP Internet protocols. The IP node 1180 may send a message to the Node Interaction Layer 1128 of the framework where the ICN-IP Translator Logic 1138 resides and is informed by the security and data object models. The ICN-IP Translator Logic 1138 may perform mapping from IP to ICN, where the mapping may include using a data model abstraction found in the data object layer to relate ICN data objects. The resulting translated data messages and protocol frames may be given to the ICN network stack for delivery. A connection to an ICN network node 1182 (e.g., a content consumer, producer, router or content store) may be established from the framework gateway using a 5G ICN that may support a variety of interaction models (e.g., NDN, NFN), where the translated IP Node interaction may be mapped to the ICN network node.

In an embodiment, an ICN originated content may be mapped to an IP destination node following a similar but reverse path through the framework. In another embodiment, the framework may host applications that may interact with the ICN network nodes according to the framework supplied data model where the ICN content abstraction is mapped to the framework data model. The framework data model may be connected to an IoT device that may produce data values into the framework data model or may consume data values from the data model such that the IoT device appears to be an ICN producer or consumer nodes.

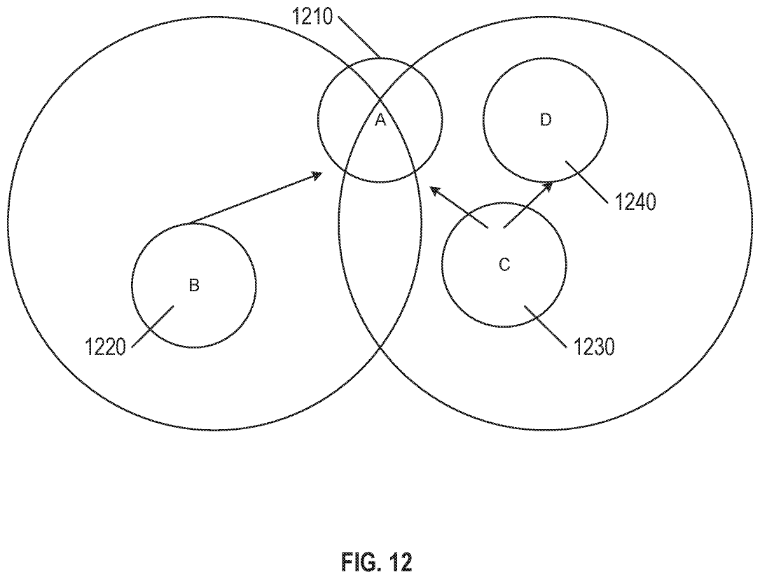

FIG. 12 is a block diagram of a wireless multi-hop network 1200, according to an embodiment. The wireless multi-hop network 1200 may be used to improve congestion control in ICN through cross-layer optimization in wireless multi-hop networks. Interest and data packet duplication in ICA may lead to throughput loss due to flooding. The collision domain graph may be used to optimize the transmissions through additional control packets that may be sent by nodes in the previous hop. A physical layer beam design may be tightly integrated to minimize duplication of packets. This may improve throughput while still maintaining latency constraints for critical applications and reduction in duplicate transmissions. This cross-layer optimization may provide significant gains, such as over 5G or mmWave.

The wireless multi-hop network 1200 may enable a next hop node to transmit a signal back to interest originators stating who needs to transmit the data packet back to the originator. This reduces or eliminates redundant transmissions and inefficient use of network resources that may be caused by flooding mechanism of interest packets and potential multiple responses in ICN. The wireless nature of the physical medium along with cross layer optimization may be used to mitigate some of the redundant transmissions.

As shown in FIG. 12, node A 1210 may receive the same interest packet from node B 1220 and node C 1230. If node A 1210 and node D 1240 respond with the requested data, then node B 1220 and node C 1230 may independently trickle it down to the interest originator. We may form a graph G(V, E) whose vertices are the nodes in the network. The edges are defined between any two nodes that are in the same collision domain e.g. in wireless it is the shared air media where simultaneous transmissions on the same time and frequency collide. Nodes with an edge may overhear each other's transmissions. Given an interest packet that is being propagated in the network and the knowledge of the network structure, it may be possible to determine which nodes are likely to respond with duplicate data packets. For example, as shown in the wireless multi-hop network 1200, based on the network structure, it is likely for node A 1210 and node D 1240 to be responding with the same data packet, and similarly for node B 1220 and node C 1230. A centralized or a distributed scheduler may determine who should transmit the packet. The centralized scheduler may schedule more than one path for duplication in order to improve reliability which could still be lesser than full flooding, Further, the scheduler may have partial knowledge of the best paths based on other interest packet or data packet routing, and this may be used to determine the flooding. Node A 1210 and node D 1240 may indicate the time of response in the data packet. Node C 1230 may use data from node A 1210 as the data packet and forward this data back to the requester. Alternatively, node C 1230 may overhear the control message of node A 1210 identify node B 1220 as the preferred destination, such as by sending part of its data transmission to node B 1220. Any of the nodes in range of node A 1210 may overhear and delete their PIT entry.

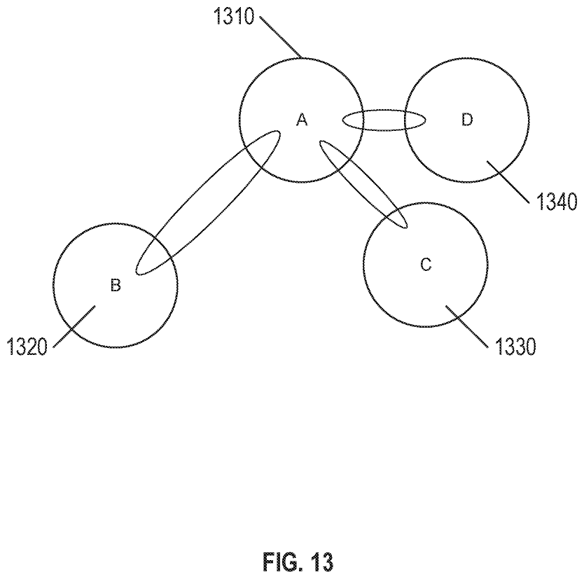

FIG. 13 is a block diagram of a multi-finger beam network 1300, according to an embodiment. The multi-finger beam network 1300 may be implemented at a physical layer to provide data to node B 1320 and a control beam to node D 1340 and node C 1330 to inform that the data has already been sent. The control beam transmitted by node A 1310 may include information about its state, such as the interest to which it is responding and to which destination nodes it is responding. This information may be shared to and used by node C 1330 and node D 1340 to determine the data to transmit.

In another embodiment, one user may send an interest packet to multiple users in a mesh network. Each of those nodes may have different entries in their FIB, so they would all be sending data to different nodes preventing interest aggregation, and the nodes may recognize this and the first node that gets the data back tells the other nodes that it has sent the data back. In another embodiment, one node may be designated as the forwarder based on whichever nodes is most likely to get the data back the quickest and the other nodes do not forward the interest packet. A message may be sent back to the original node indicating a time when it is expected to receive the data.

In a decentralized scenario, a Response-Wait-Timer may be used to determine who transmits the data first. A node with a better link quality may have a wait timer that is shorter than another node after hearing an interest packet. The first node may respond first and based on the side-lobe information of the other node, may decide not to transmit the packet.

In an embodiment, a field may be added (e.g., into MetaInfo) with information of the intended receiver. Using that information, other nodes may know that they are not the intended receivers and they remove the entry in their PIT table. This may be achieved with only one transmission (e.g., one data packet).

In another embodiment, instead of adding a field, one may add an assigned number to the ContentType, and this special packet may have two ContentTypes. The first may be set to 0, such as to denote the its payload is data. The second may denote the intended receiver.

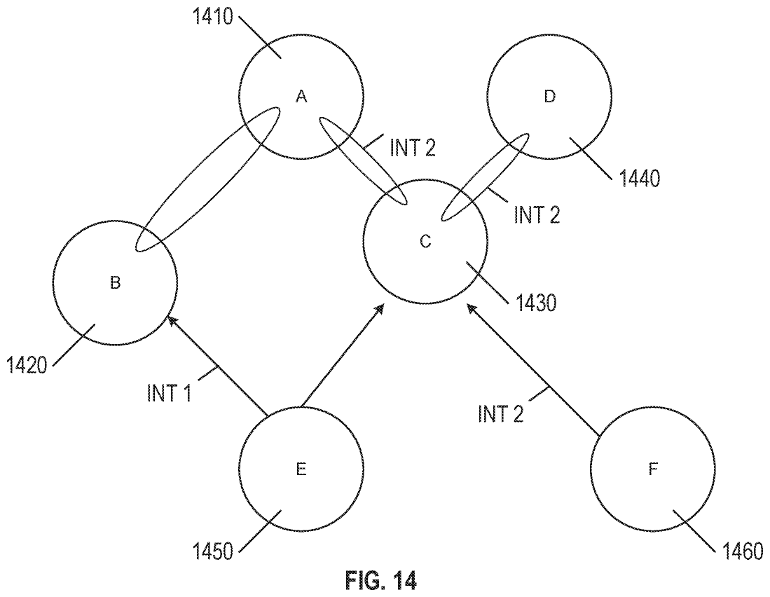

FIG. 14 is a block diagram of a multicasting network 1400, according to an embodiment. A given intermediate node may have multiple interests that needs to be transmitted. Instead of flooding all the interests to all the next hop nodes, the multicasting network 1400 may use an intelligent multi-finger beam based on the learned network structure, which may also be applied to data packets. The nodes may use a multi-finger beam with multiplexing to decide what data packets should. be sent on which beams. The beam designer at the physical layer may have inputs as the interference graph, the interest packets to be sent and the next-hop and the beam pattern is determined to minimize duplication of packets. The control beams and the interest beams may be sent as separate beams. However, at the physical layer, given the knowledge of the higher layer, the spectral efficiency may be improved if we may design the beams based on the side information of interest packets or data packets and the network structure.

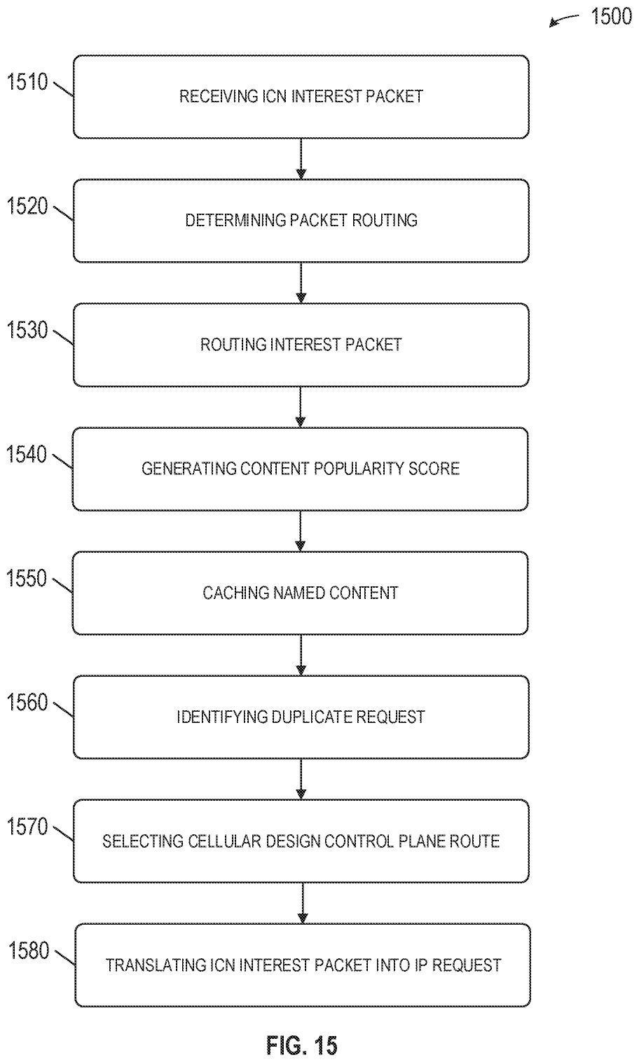

FIG. 15 is an example of a method 1500 for network function execution, according to an embodiment. Method 1500 may include receiving 1510 an ICN interest packet, where the interest packet includes a request for named information. Method 1500 may include determining 1520 a packet routing based on the ICA interest packet and a network configuration, and routing 1530 the interest packet based on the determined packet routing.

Method 1500 may include generating 1540 a content popularity score associated with the named information. The determination 1520 of the packet routing may be further based on the content popularity score. The generation 1540 of the content popularity score may include receiving the named content at a base station, collecting a plurality of interest statistics at the base station, and generating an interest pattern associated with the named content based on the collected plurality of interest statistics. The generation of the content popularity score may be based on the generated interest pattern. The interest statistics may indicate a network popularity associated with the named content.

Method 1500 may include caching 1550 the named content at the base station based on the generated content popularity score. The caching of the named content occurs during a cellular handover of the producer of the named content. The caching of the named content occurs during a cellular handover of the consumer of the named content. The generated content popularity score may be equal to or greater than a first threshold, and the named content may be cached before receipt of a cellular handover trigger. The generated content popularity score may be below a first threshold and equal to or greater than a second threshold, and the named content may be cached in response to receipt of the cellular handover trigger. The generated content popularity score may be below the second threshold and equal to or greater than a third threshold, and the named content may be cached after the cellular handover may be completed. The generated content popularity score may be less than the third threshold, and the named content may be not cached. The caching of the named content may occur before a content producer transitions to an idle state. A plurality of network information may be exchanged via a plurality of network nodes.

Method 1500 may include identifying 1560 a duplicate request for the named information based on the interest packet and a prior packet, and identifying a common ICN node based on the network configuration. The prior packet may be received from a first requesting ICN node and the interest packet received from a second requesting ICN node. The common ICN node may be in network communication with the first requesting ICN node and the second requesting ICN node. The determination 1520 of the packet routing may be further based on sending the named information through the common ICN node to the first requesting ICN node and the second requesting ICN node. A control beam may be generated at the common ICN node, where the control beam may include information describing the network configuration and a plurality of received packets. The control beam may be sent from the common ICN node to a plurality of connected nodes. A multi-finger beam may be generated based on the network configuration. The generated multi-finger beam may reduce duplication of interest and data packet duplication.

Method 1500 may include selecting 1570 the cellular design control plane route. The ICA interest packet may be received at a cellular ICA node within a cellular ICN network. The cellular ICN network may include an ICN transmission user plane route and a cellular design control plane route. The determination 1520 of the packet routing may include selecting the cellular design control plane route. The determination 1520 of the packet routing may be further based on at least one of a packet size associated with the interest packet, a user cellular radio resource control mode, a user cellular communication capability, and a cellular base station capability.

Method 1500 may include translating 1580 the received ICN interest packet into an IP request at a network translation orchestrator. The determination 1520 of the packet routing may be further based on a routing of the IP request to an IP network. A second IP request may be received from the IP network. The received second IP request may be translated to a second ICN interest packet at the network translation orchestrator, and an IP routing may be determined based on the second IP request, and routing the interest packet based on the determined IP routing.

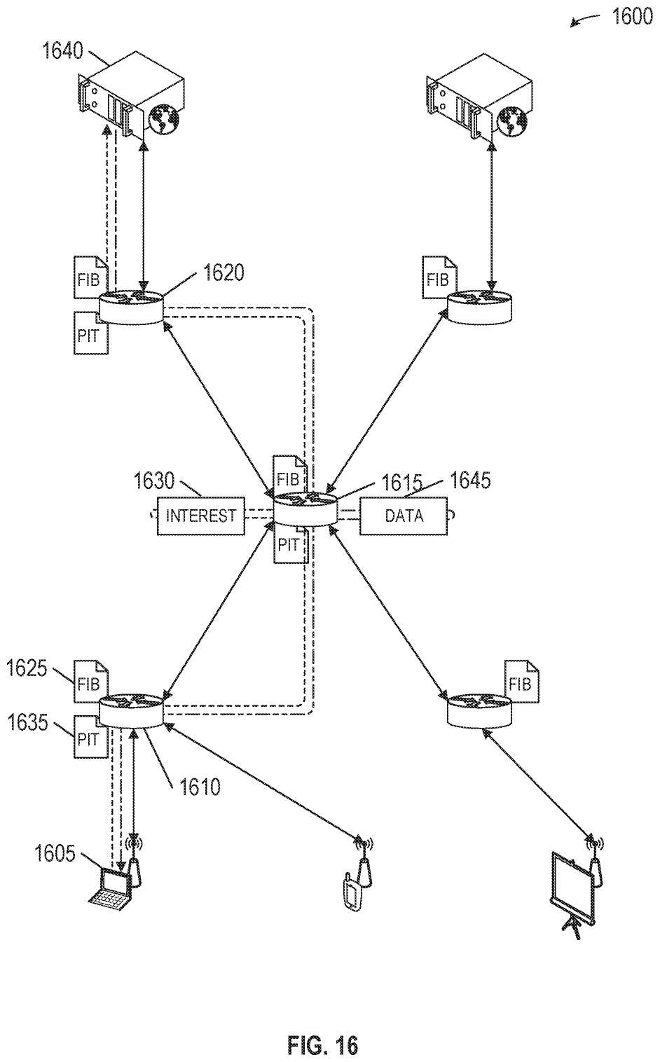

FIG. 16 illustrates an example ICN 1600, according to an embodiment. ICNs operate differently than traditional host-based (e.g., address-based) communication networks. ICN is an umbrella term for a networking paradigm in which information itself is named and requested from the network instead of hosts (e.g., machines that provide information). In a host-based networking paradigm, such as used in the Internet protocol (IP), a device locates a host and requests content from the host. The network understands how to route (e.g., direct) packets based on the address specified in the packet. In contrast, ICN does not include a request for a particular machine and does not use addresses. Instead, to get content, a device 1605 (e.g., subscriber) requests named content from the network itself. The content request may be called an interest and transmitted via an interest packet 1630. As the interest packet traverses network devices (e.g., network elements, routers, switches, hubs, etc.)—such as network elements 1610, 1615, and 1620—a record of the interest is kept, for example, in a pending interest table (PIT) at each network element. Thus, network element 1610 maintains an entry in its PIT 1635 for the interest packet 1630, network element 1615 maintains the entry in its PIT, and network element 1620 maintains the entry in its PIT.

When a device, such as publisher 1640, that has content matching the name in the interest packet 1630 is encountered, that device 1640 may send a data packet 1645 in response to the interest packet 1630. Typically, the data packet 1645 is tracked back through the network to the source (e.g., device 1605) by following the traces of the interest packet 1630 left in the network element PITs. Thus, the PIT 1635 at each network element establishes a trail back to the subscriber 1605 for the data packet 1645 to follow.

Matching the named data in an ICN may follow several strategies. Generally, the data is named hierarchically, such as with a universal resource identifier (URI). For example, a video may be named www.somedomain.com or videos or v8675309. Here, the hierarchy may be seen as the publisher, “www.somedomain.com,” a sub-category, “videos,” and the canonical identification “v8675309.” As an interest 1630 traverses the ICN, ICN network elements will generally attempt to match the name to a greatest degree. Thus, if an ICN element has a cached item or route for both “www.somedomain.com or videos” and “www.somedomain.com or videos or v8675309,” the ICN element will match the later for an interest packet 1630 specifying “www.somedomain.com or videos or v8675309.” In an example, an expression may be used in matching by the ICN device. For example, the interest packet may specify “www.somedomain.com or videos or v8675*” where ‘*’ is a wildcard. Thus, any cached item or route that includes the data other than the wildcard will be matched.

Item matching involves matching the interest 1630 to data cached in the ICN element. Thus, for example, if the data 1645 named in the interest 1630 is cached in network element 1615, then the network element 1615 will return the data 1645 to the subscriber 1605 via the network element 1610. However, if the data 1645 is not cached at network element 1615, the network element 1615 routes the interest 1630 on (e.g., to network element 1620). To facilitate routing, the network elements may use a forwarding information base 1625 (FIB) to match named data to an interface (e.g., physical port) for the route. Thus, the FIB 1625 operates much like a routing table on a traditional network device.

In an example, additional meta-data may be attached to the interest packet 1630, the cached data, or the route (e.g., in the FIB 1625), to provide an additional level of matching. For example, the data name may be specified as “www.somedomain.com or videos or v8675309,” but also include a version number—or timestamp, time range, endorsement, etc. In this example, the interest packet 1630 may specify the desired name, the version number, or the version range. The matching may then locate routes or cached data matching the name and perform the additional comparison of meta-data or the like to arrive at an ultimate decision as to whether data or a route matches the interest packet 1630 for respectively responding to the interest packet 1630 with the data packet 1645 or forwarding the interest packet 1630.

ICN has advantages over host-based networking because the data segments are individually named. This enables aggressive caching throughout the network as a network element may provide a data packet 1630 in response to an interest 1630 as easily as an original author 1640. Accordingly, it is less likely that the same segment of the network will transmit duplicates of the same data requested by different devices.

Fine grained encryption is another feature of many ICN networks. A typical data packet 1645 includes a name for the data that matches the name in the interest packet 1630. Further, the data packet 1645 includes the requested data and may include additional information to filter similarly named data (e.g., by creation time, expiration time, version, etc.), To address malicious entities providing false information under the same name, the data packet 1645 may also encrypt its contents with a publisher key or provide a cryptographic hash of the data and the name. Thus, knowing the key (e.g., from a certificate of an expected publisher 1640) enables the recipient to ascertain whether the data is from that publisher 1640. This technique also facilitates the aggressive caching of the data packets 1645 throughout the network because each data packet 1645 is self-contained and secure. In contrast, many host-based networks rely on encrypting a connection between two hosts to secure communications. This may increase latencies while connections are being established and prevents data caching by hiding the data from the network elements.

Example ICN networks include content centric networking (CCN), as specified in the Internet Engineering Task Force (IETF) draft specifications for CCNx 0.x and CCN 1.x, Data-Oriented Network Architecture (DONA), as presented at proceedings of the 2007 Association for Computing Machinery's (ACM) Special Interest Group on Data Communications (SIGCOMM) conference on Applications, technologies, architectures, and protocols for computer communications, Named Functions Networking (NFN), 4WARD, Content Aware Searching, Retrieval and Streaming (COAST), Convergence of Fixed and Mobile Broadband Access/Aggregation Networks (COMBO), Content Mediator Architecture for Content-Aware Networks (COMET), CONVERGENCE, GreenICN, Network of Information (NetInf), IP Over ICN (POINT), Publish-Subscribe Internet Routing Paradigm (PSIRP), Publish Subscribe Internet Technology (PURSUIT), Scalable and Adaptive Internet Solutions (SAIL), Universal, Mobile-Centric and Opportunistic Communications Architecture (UMOBILE), etc.

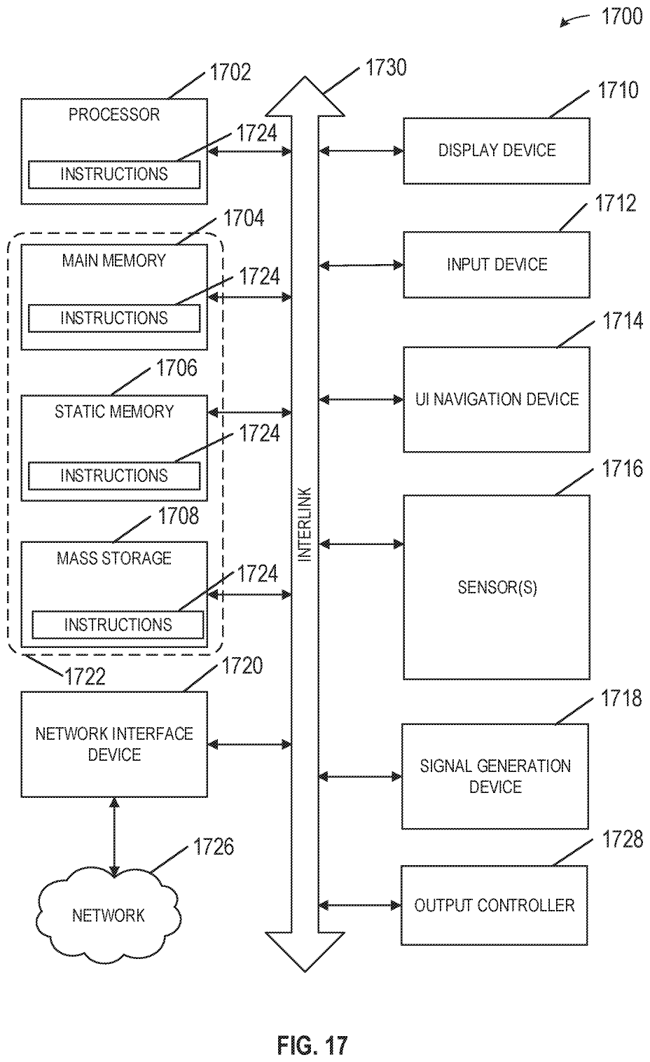

FIG. 17 illustrates a block diagram of an example machine 1700 upon which any one or more of the techniques (e.g., methodologies) discussed herein may perform. Examples, as described herein, may include, or may operate by, logic or a number of components, or mechanisms in the machine 1700. Circuitry (e.g., processing circuitry) is a collection of circuits implemented in tangible entities of the machine 1700 that include hardware (e.g., simple circuits, gates, logic, etc.). Circuitry membership may be flexible over time. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1700 follow.

In alternative embodiments, the machine 1700 may opera as a standalone device or may be connected (e.g., networked) to other machines. In a networked deployment, the machine 1700 may operate in the capacity of a server machine, a client machine, or both in server-client network environments. In an example, the machine 1700 may act as a peer machine in peer-to-peer (P2P) (or other distributed) network environment. The machine 1700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” may also be taken to include any collection of machines that individually or jointly execute a set (or multiple sets) of instructions to perform any one or more of the methodologies discussed herein, such as cloud computing, software as a service (SaaS), other computer cluster configurations.

The machine (e.g., computer system) 1700 may include a hardware processor 1702 (e.g., a central processing unit (CPU), a graphics processing unit (GPU), a hardware processor core, or any combination thereof), a main memory 1704, a static memory (e.g., memory or storage for firmware, microcode, a basic-input-output (BIOS), unified extensible firmware interface (UEFI), etc.) 1706, and mass storage 1708 (e.g., hard drive, tape drive, flash storage, or other block devices) some or all of which may communicate with each other via an interlink (e.g., bus) 1730. The machine 1700 may further include a display unit 1710, an alphanumeric input device 1712 (e.g., a keyboard), and a user interface (UI) navigation device 1714 (e.g., a mouse). In an example, the display unit 1710, input device 1712 and UI navigation device 1714 may be a touch screen display. The machine 1700 may additionally include a storage device (e.g., drive unit) 1708, a signal generation device 1718 (e.g., a speaker), a network interface device 1720, and one or more sensors 1716, such as a global positioning system (GPS) sensor, compass, accelerometer, or another sensor. The machine 1700 may include an output controller 1728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1702, the main memory 1704, the static memory 1706, or the mass storage 1708 may be, or include, a machine-readable medium 1722 on which is stored one or more sets of data structures or instructions 1724 (e.g., software) embodying or utilized by any one or more of the techniques or functions described herein. The instructions 1724 may also reside, completely or at least partially, within any of registers of the processor 1702, the main memory 1704, the static memory 1706, or the mass storage 1708 during execution thereof by the machine 1700. In an example, one or any combination of the hardware processor 1702, the main memory 1704, the static memory 1706, or the mass storage 1708 may constitute the machine-readable media 1722. While the machine-readable medium 1722 is illustrated as a single medium, the term “machine-readable medium” may include a single medium or multiple media (e.g., a centralized or distributed database, and/or associated caches and servers)configured to store the one or more instructions 1724.

The term “machine-readable medium” may include any medium that is capable of storing, encoding, or carrying instructions for execution by the machine 1700 and that cause the machine 1700 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon based signals, sound signals, etc.). In an example, a non-transitory machine-readable medium comprises a machine-readable medium with a plurality of particles having invariant (e.g., rest) mass, and thus are compositions of matter. Accordingly, non-transitory machine-readable media are machine-readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1724 may be further transmitted or received over a communications network 1726 using a transmission medium via the network interface device 1720 utilizing any one of a number of transfer protocols (e.g., frame relay, internee protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1720 may include one or more physical jacks (e.g., Ethernet, coaxial, or phone jacks) or one or more antennas to connect to the communications network 1726. In an example, the network interface device 1720 may include a plurality of antennas to wirelessly communicate using at least one of single-input multiple-output (SIMO), multiple-input multiple-output (MIMO), or multiple-input single-output (MISO) techniques. The term “transmission medium” may be taken to include any intangible medium that is capable of storing, encoding or carrying instructions for execution by the machine 1700, and includes digital or analog communications signals or other intangible medium to facilitate communication of such software. A transmission medium is a machine-readable medium.

### Additional Notes & Examples

Example 1 is an information-centric network system, the system comprising: processing circuitry; and a memory that includes instructions, the instructions, when executed by the processing circuitry, cause the processing circuitry to: receive an information-centric network (ICN) interest packet, the interest packet including a request for named information; generate a content popularity score associated with the named information; and caching the named content at the base station based on the generated content popularity score.

In Example 2, the subject matter of Example 1 optionally includes the instructions further causing the processing circuitry to: receive the named content at a base station; collect a plurality of interest statistics at the base station, the interest statistics indicating a network popularity associated with the named content; and generate an interest pattern associated with the named content based on the collected plurality of interest statistics; wherein the generation of the content popularity score is based on the generated interest pattern.

In Example 3, the subject matter of any one or more of Examples 1-2 optionally include the instructions further causing the processing circuitry to determine a packet route based on the content popularity score, the ICN interest packet, and a network configuration.

In Example 4, the subject matter of Example 3 optionally includes wherein the caching of the named content occurs during a cellular handover of the producer of the named content.

In Example 5, the subject matter of any one or more of Examples 3-4 optionally include wherein the caching of the named content occurs during a cellular handover of the consumer of the named content.

In Example 6, the subject matter of any one or more of Examples 1-5 optionally include wherein: the generated content popularity score is equal to or greater than a first threshold; and the named content is cached before receipt of a cellular handover trigger.

In Example 7, the subject matter of any one or more of Examples 1-6 optionally include wherein: the generated content popularity score is below a first threshold and equal to or greater than a second threshold; and the named content is cached in response to receipt of the cellular handover trigger.

In Example 8, the subject matter of any one or more of Examples 1-7 optionally include wherein: the generated content popularity score is below the second threshold and equal to or greater than a third threshold; and the named content is cached after the cellular handover is completed.

In Example 9, the subject matter of any one or more of Examples 1-8 optionally include wherein: the generated content popularity score is less than the third threshold; and the named content is not cached.

In Example 10, the subject matter of any one or more of Examples 1-9 optionally include the instructions further causing the processing circuitry to cache the named content before a content producer transitions to an idle state.

In Example 11, the subject matter of any one or more of Examples 1-10 optionally include the instructions further causing the processing circuitry to exchange a plurality of network information via a plurality of network nodes.

In Example 12, the subject matter of any one or more of Examples 3-11 optionally include the instructions further causing the processing circuitry to: identify a duplicate request for the named information based on the interest packet and a prior packet, the prior packet received from a first requesting ICN node and the interest packet received from a second requesting ICN node; and identify a common ICN node based on the network configuration, the common ICN node in network communication with the first requesting ICN node and the second requesting ICN node; wherein the determination of the packet route is further based on sending the named information through the common ICN node to the first requesting ICN node and the second requesting ICN node.

In Example 13, the subject matter of Example 12 optionally includes the instructions further causing the processing circuitry to: generate a control beam at the common ICN node, the control beam including information describing the network configuration and a plurality of received packets; and send the control beam from the common ICN node to a plurality of connected nodes.

In Example 14, the subject matter of any one or more of Examples 12-13 optionally include the instructions further causing the processing circuitry to generate a multi-finger beam based on the network configuration, the generated multi-finger beam to reduce duplication of interest and data packet duplication.

In Example 15, the subject matter of any one or more of Examples 3-14 optionally include wherein: the ICN interest packet is received at a cellular ICN node within a cellular ICN network; the cellular ICN network includes an ICN transmission user plane route and a cellular design control plane route; and the determination of the packet route includes selecting the cellular design control plane route.

In Example 16, the subject matter of any one or more of Examples 3-15 optionally include wherein the determination of the packet route is further based on at least one of a packet size associated with the interest packet, a user cellular radio resource control mode, a user cellular communication capability, and a cellular base station capability.

In Example 17, the subject matter of any one or more of Examples 3-16 optionally include the instructions further causing the processing circuitry to translate the received ICN interest packet into an IP request at a network translation orchestrator, wherein the determination of the packet route is further based on a route of the IP request to an IP network.

In Example 18, the subject matter of Example 17 optionally includes the instructions further causing the processing circuitry to: receive a second IP request from the IP network; translate the received second IP request to a second ICN interest packet at the network translation orchestrator; determine an IP route based on the second 1P request; and route the interest packet based on the determined IP route.

Example 19 is an information-centric network communication method comprising: receiving an information-centric network (ICN) interest packet, the interest packet including a request for named information; generating a content popularity score associated with the named information; and caching the named content at the base station based on the generated content popularity score.

In Example 20, the subject matter of Example 19 optionally includes receiving the named content at a base station; collecting a plurality of interest statistics at the base station, the interest statistics indicating a network popularity associated with the named content; and generating an interest pattern associated with the named content based on the collected plurality of interest statistics; wherein the generation of the content popularity score is based on the generated interest pattern.

In Example 21, the subject matter of any one or more of Examples 19-20 optionally include determining a packet route based on the content popularity score, the ICN interest packet, and a network configuration.

In Example 22, the subject matter of Example 21 optionally includes wherein the caching of the named content occurs during a cellular handover of the producer of the named content.

In Example 23, the subject matter of any one or more of Examples 21-22 optionally include wherein the caching of the named content occurs during a cellular handover of the consumer of the named content.

In Example 24, the subject matter of any one or more of Examples 21-23 optionally include wherein: the generated content popularity score is equal to or greater than a first threshold; and the named content is cached before receipt of a cellular handover trigger.

In Example 25, the subject matter of any one or more of Examples 21-24 optionally include wherein: the generated content popularity score is below a first threshold and equal to or greater than a second threshold; and the named content is cached in response to receipt of the cellular handover trigger.

In Example 26, the subject matter of any one or more of Examples 21-25 optionally include wherein: the generated content popularity score is below the second threshold and equal to or greater than a third threshold; and the named content is cached after the cellular handover is completed.

In Example 27, the subject matter of any one or more of Examples 21-26 optionally include wherein: the generated content popularity score is less than the third threshold; and the named content is not cached.

In Example 28, the subject matter of any one or more of Examples 19-27 optionally include caching the named content before a content producer transitions to an idle state.

In Example 29, the subject matter of any one or more of Examples 19-28 optionally include exchanging a plurality of network information via a plurality of network nodes.

In Example 30, the subject matter of any one or more of Examples 21-29 optionally include identifying a duplicate request for the named information based on the interest packet and a prior packet, the prior packet received from a first requesting ICN node and the interest packet received from a second requesting ICN node; and identifying a common ICN node based on the network configuration, the common ICN node in network communication with the first requesting ICN node and the second requesting ICN node; wherein the determination of the packet routing is further based on sending the named information through the common ICN node to the first requesting ICN node and the second requesting ICN node.

In Example 31, the subject matter of Example 30 optionally includes generating a control beam at the common ICN node, the control beam including information describing the network configuration and a plurality of received packets; and sending the control beam from the common ICN node to a plurality of connected nodes.

In Example 32, the subject matter of any one or more of Examples 30-31 optionally include generating a multi-finger beam based on the network configuration, the generated multi-finger beam to reduce duplication of interest and data packet duplication.

In Example 33, the subject matter of any one or more of Examples 21-32 optionally include wherein: the ICN interest packet is received at a cellular ICN node within a cellular ICN network; the cellular ICN network includes an ICN transmission user plane route and a cellular design control plane route; and the determination of the packet routing includes selecting the cellular design control plane route.

In Example 34, the subject matter of any one or more of Examples 21-33 optionally include wherein the determination of the packet routing is further based on at least one of a packet size associated with the interest packet, a user cellular radio resource control mode, a user cellular communication capability, and a cellular base station capability.

In Example 35, the subject matter of any one or more of Examples 21-34 optionally include translating the received ICN interest packet into an IP request at a network translation orchestrator, wherein the determination of the packet routing is further based on a routing of the IP request to an IP network.

In Example 36, the subject matter of Example 35 optionally includes receiving a second IP request from the IP network; translating the received second IP request to a second ICN interest packet at the network translation orchestrator; determining an IP routing based on the second IP request; and routing the interest packet based on the determined IP routing.

Example 37 is at least one machine-readable medium including instructions, which when executed by a computing system, cause the computing system to perform any of the methods of Examples 19-36.

Example 38 is an apparatus comprising means for performing any of the methods of Examples 19-36.

Example 39 is at least one non-transitory machine-readable storage medium, comprising a plurality of instructions that, responsive to being executed with processor circuitry of a computer-controlled device, cause the computer-controlled device to: receive an information-centric network (ICN) interest packet, the interest packet including a request for named information; generate a content popularity score associated with the named information; and cache the named content at the base station based on the generated content popularity score.

In Example 40, the subject matter of Example 39 optionally includes the instructions further causing the processing circuitry to: receive the named content at a base station; collect a plurality of interest statistics at the base station, the interest statistics indicating a network popularity associated with the named content; and generate an interest pattern associated with the named content based on the collected plurality of interest statistics; wherein the generation of the content popularity score is based on the generated interest pattern.

In Example 41, the subject matter of any one or more of Examples 39-40 optionally include the instructions further causing the processing circuitry to determine a packet route based on the content popularity score, the ICN interest packet, and a network configuration.

In Example 42, the subject matter of Example 41 optionally includes wherein the caching of the named content occurs during a cellular handover of the producer of the named content.

In Example 43, the subject matter of any one or more of Examples 41-42 optionally include wherein the caching of the named content occurs during a cellular handover of the consumer of the named content.

In Example 44, the subject matter of any one or more of Examples 41-43 optionally include wherein: the generated content popularity score is equal to or greater than a first threshold; and the named content is cached before receipt of a cellular handover trigger.

In Example 45, the subject matter of any one or more of Examples 41-44 optionally include wherein: the generated content popularity score is below a first threshold and equal to or greater than a second threshold; and the named content is cached in response to receipt of the cellular handover trigger

In Example 46, the subject matter of any one or more of Examples 41-45 optionally include wherein: the generated content popularity score is below the second threshold and equal to or greater than a third threshold; and the named content is cached after the cellular handover is completed.

In Example 47, the subject matter of any one or more of Examples 41-46 optionally include wherein: the generated content popularity score is less than the third threshold; and the named content is not cached.

In Example 48, the subject matter of any one or more of Examples 39-47 optionally include the instructions further causing the processing circuitry to cache the named content before a content producer transitions to an idle state.

In Example 49, the subject matter of any one or more of Examples 39-48 optionally include the instructions further causing the processing circuitry to exchange a plurality of network information via a plurality of network nodes.

In Example 50, the subject matter of any one or more of Examples 41-49 optionally include the instructions further causing the processing circuitry to: identify a duplicate request for the named information based on the interest packet and a prior packet, the prior packet received from a first requesting ICN node and the interest packet received from a second requesting ICN node; and identify a common ICN node based on the network configuration, the common ICN node in network communication with the first requesting ICN node and the second requesting ICN node; wherein the determination of the packet route is further based on sending the named information through the common ICN node to the first requesting ICN node and the second requesting ICN node.

In Example 51, the subject matter of Example 50 optionally includes the instructions further causing the processing circuitry to: generate a control beam at the common ICN node, the control beam including information describing the network configuration and a plurality of received packets; and send the control beam from the common ICN node to a plurality of connected nodes.

In Example 52, the subject matter of any one or more of Examples 50-51 optionally include the instructions further causing the processing circuitry to generate a multi-finger beam based on the network configuration, the generated multi-finger beam to reduce duplication of interest and data packet duplication.

In Example 53, the subject matter of any one or more of Examples 41-52 optionally include wherein: the ICN interest packet is received at a cellular ICN node within a cellular ICN network; the cellular ICN network includes an ICN transmission user plane route and a cellular design control plane route; and the determination of the packet route includes selecting the cellular design control plane route.

In Example 54, the subject matter of any one or more of Examples 41-53 optionally include wherein the determination of the packet route is further based on at least one of a packet size associated with the interest packet, a user cellular radio resource control mode, a user cellular communication capability, and a cellular base station capability.

In Example 55, the subject matter of any one or more of Examples 41-54 optionally include the instructions further causing the processing circuitry to translate the received ICN interest packet into an IP request at a network translation orchestrator, wherein the determination of the packet route is further based on a route of the IP request to an IP network.

In Example 56, the subject matter of Example 55 optionally includes the instructions further causing the processing circuitry to: receive a second IP request from the IP network; translate the received second IP request to a second ICN interest packet at the network translation orchestrator; determine an IP route based on the second IP request; and route the interest packet based on the determined IP route.

Example 57 is an information-centric network communication apparatus comprising: means for means for receiving an information-centric network (ICN) interest packet, the interest packet including a request for named information; means for generating a content popularity score associated with the named information; and means for caching the named content at the base station based on the generated content popularity score.

In Example 58, the subject matter of Example 57 optionally includes means for receiving the named content at a base station; means for collecting a plurality of interest statistics at the base station, the interest statistics indicating a network popularity associated with the named content; and means for generating an interest pattern associated with the named content based on the collected plurality of interest statistics; wherein the means for generating of the content popularity score is based on the generated interest pattern.

In Example 59, the subject matter of any one or more of Examples 57-58 optionally include means for determining a packet route based on the content popularity score, the ICN interest packet, and a network configuration.

In Example 60, the subject matter of Example 59 optionally includes wherein the means for caching of the named content occurs during a cellular handover of the producer of the named content.

In Example 61, the subject matter of any one or more of Examples 59-60 optionally include wherein the means for caching of the named content occurs during a cellular handover of the consumer of the named content.

In Example 62, the subject matter of any one or more of Examples 59-61 optionally include wherein: the generated content popularity score is equal to or greater than a first threshold; and the named content is cached before receipt of a cellular handover trigger.

In Example 63, the subject matter of any one or more of Examples 59-62 optionally include wherein: the generated content popularity score is below a first threshold and equal to or greater than a second threshold; and the named content is cached in response to receipt of the cellular handover trigger.

In Example 64, the subject matter of any one or more of Examples 59-63 optionally include wherein: the generated content popularity score is below the second threshold and equal to or greater than a. third threshold; and the named content is cached after the cellular handover is completed.

In Example 65, the subject matter of any one or more of Examples 59-64 optionally include wherein: the generated content popularity score is less than the third threshold; and the named content is not cached.

In Example 66, the subject matter of any one or more of Examples 57-65 optionally include means for caching the named content before a content producer transitions to an idle state.

In Example 67, the subject matter of any one or more of Examples 57-66 optionally include means for exchanging a plurality of network information via a plurality of network nodes.

In Example 68, the subject matter of any one or more of Examples 59-67 optionally include means for identifying a duplicate request for the named information based on the interest packet and a prior packet, the prior packet received from a first requesting ICN node and the interest packet received from a second requesting ICN node; and means for identifying a common ICN node based on the network configuration, the common ICN node in network communication with the first requesting ICN node and the second requesting ICN node; wherein the means for determining the packet routing is further based on sending the named information through the common ICN node to the first requesting ICN node and the second requesting ICN node.

In Example 69, the subject matter of Example 68 optionally includes means for generating a control beam at the common ICN node, the control beam including information describing the network configuration and a plurality of received packets; and means for sending the control beam from the common ICN node to a plurality of connected nodes.

In Example 70, the subject matter of any one or more of Examples 68-69 optionally include means for generating a multi-finger beam based on the network configuration, the generated multi-finger beam to reduce duplication of interest and data packet duplication.

In Example 71, the subject matter of any one or more of Examples 59-70 optionally include wherein: the ICN interest packet is received at a cellular ICN node within a cellular ICN network; the cellular ICN network includes an ICN transmission user plane route and a cellular design control plane route; and the means for determining the packet routing includes selecting the cellular design control plane route.

In Example 72, the subject matter of any one or more of Examples 59-71 optionally include wherein the means for determining the packet routing is further based on at least one of a packet size associated with the interest packet, a user cellular radio resource control mode, a user cellular communication capability, and a cellular base station capability.

In Example 73, the subject matter of any one or more of Examples 59-72 optionally include means for translating the received ICN interest packet into an IP request at a network translation orchestrator, wherein the determination of the packet routing is further based on a routing of the IP request to an IP network.

In Example 74, the subject matter of Example 73 optionally includes means for receiving a second IP request from the IP network; means for translating the received second. IP request to a second ICN interest packet at the network translation orchestrator; means for determining an IP routing based on the second IP request; and means for routing the interest packet based on the determined IP routing.

Example 75 is at least one machine-readable medium including instructions, which when executed by a machine, cause the machine to perform operations of any of the operations of Examples 1-74.

Example 76 is an apparatus comprising means for performing any of the operations of Examples 1-74.

Example 77 is a system to perform the operations of any of the Examples 1-74.

Example 78 is a method to perform the operations of any of the Examples 1-74.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. An information-centric network system, the system comprising:
processing circuitry; and
a memory that includes instructions, the instructions, when executed by the processing circuitry, cause the processing circuitry to:
receive an information-centric network (ICN) interest packet, the interest packet including a request for named information;
generate a content popularity score associated with the named information; and
caching the named content at the base station based on the generated content popularity score.

2. The system of claim 1, the instructions further causing the processing circuitry to:
receive the named content at a base station;
collect a plurality of interest statistics at the base station, the interest statistics indicating a network popularity associated with the named content; and
generate an interest pattern associated with the named content based on the collected plurality of interest statistics;
wherein the generation of the content popularity score is based on the generated interest pattern.

3. The system of claim 1, the instructions further causing the processing circuitry to determine a packet route based on the content popularity score, the ICN interest packet, and a network configuration.

4. The system of claim 1, wherein:
the generated content popularity score is equal to or greater than a first threshold; and
the named content is cached before receipt of a cellular handover trigger.

5. The system of claim 3, the instructions further causing the processing circuitry to:
identify a duplicate request for the named information based on the interest packet and a prior packet, the prior packet received from a first requesting ICN node and the interest packet received from a second requesting ICN node; and
identify a common ICN node based on the network configuration, the common ICN node in network communication with the first requesting ICN node and the second requesting ICN node;
wherein the determination of the packet route is further based on sending the named information through the common ICN node to the first requesting ICN node and the second requesting ICN node.

6. The system of claim 5, the instructions further causing the processing circuitry to:
generate a control beam at the common ICN node, the control beam including information describing the network configuration and a plurality of received packets; and
send the control beam from the common ICN node to a plurality of connected nodes.

7. The system of claim 3, wherein:
the ICN interest packet is received at a cellular ICN node within a cellular ICN network;
the cellular ICN network includes an ICN transmission user plane route and a cellular design control plane route; and
the determination of the packet route includes selecting the cellular design control plane route.

8. The system of claim 3, the instructions further causing the processing circuitry to translate the received ICN interest packet into an IP request at a network translation orchestrator, wherein the determination of the packet route is further based on a route of the IP request to an IP network.

9. An information-centric network communication method comprising:
receiving an information-centric network (ICN) interest packet, the interest packet including a request for named information;
generating a content popularity score associated with the named information; and
caching the named content at the base station based on the generated content popularity score.

10. The method of claim 9, further including:
receiving the named content at a base station;
collecting a plurality of interest statistics at the base station, the interest statistics indicating a network popularity associated with the named content; and
generating an interest pattern associated with the named content based on the collected plurality of interest statistics;
wherein the generation of the content popularity score is based on the generated interest pattern.

11. The method of claim 9, further including determining a packet route based on the content popularity score, the ICN interest packet, and a network configuration.

12. The method of claim 11, wherein:
the generated content popularity score is equal to or greater than a first threshold; and
the named content is cached before receipt of a cellular handover trigger.

13. The method of claim 11, further including:
identifying a duplicate request for the named information based on the interest packet and a prior packet, the prior packet received from a first requesting ICN node and the interest packet received from a second requesting ICN node; and
identifying a common ICN node based on the network configuration, the common ICN node in network communication with the first requesting ICN node and the second requesting ICN node;
wherein the determination of the packet routing is further based on sending the named information through the common ICN node to the first requesting ICN node and the second requesting ICN node.

14. The method of claim 13, further including:
generating a control beam at the common ICN node, the control beam including information describing the network configuration and a plurality of received packets; and
sending the control beam from the common ICN node to a plurality of connected nodes.

15. The method of claim 13, further including generating a multi-finger beam based on the network configuration, the generated multi-finger beam to reduce duplication of interest and data packet duplication.

16. The method of claim 11, wherein:
the ICN interest packet is received at a cellular ICA node within a cellular ICN network;
the cellular ICN network includes an RN transmission user plane route and a cellular design control plane route; and
the determination of the packet routing includes selecting the cellular design control plane route.

17. The method of claim 11, wherein the determination of the packet routing is further based on at least one of a packet size associated with the interest packet, a user cellular radio resource control mode, a user cellular communication capability, and a cellular base station capability.

18. The method of claim 11, further including translating the received ICN interest packet into an IP request at a network translation orchestrator, wherein the determination of the packet routing is further based on a routing of the IP request to an IP network.

19. The method of claim 18, further including:
receiving a second IP request from the IP network;
translating the received second IP request to a second ICN interest packet at the network translation orchestrator;
determining an IP routing based on the second IP request; and
routing the interest packet based on the determined IP routing.

20. At least one non-transitory machine-readable storage medium, comprising a plurality of instructions that, responsive to being executed with processor circuitry of a computer-controlled device, cause the computer-controlled device to:
receive an information-centric network (ICN) interest packet, the interest packet including a request for named information;
generate a content popularity score associated with the named information; and
cache the named content at the base station based on the generated content popularity score.

21. The non-transitory machine-readable storage medium of claim 20, the instructions further causing the processing circuitry to:
receive the named content at a base station;
collect a plurality of interest statistics at the base station, the interest statistics indicating a network popularity associated with the named content; and
generate an interest pattern associated with the named content based on the collected plurality of interest statistics;
wherein the generation of the content popularity score is based on the generated interest pattern.

22. The non-transitory machine-readable storage medium of claim 20, the instructions further causing the processing circuitry to determine a packet route based on the content popularity score, the ICN interest packet, and a network configuration.

23. The non-transitory machine-readable storage medium of claim 22, the instructions further causing the processing circuitry to:
identify a duplicate request for the named information based on the interest packet and a prior packet, the prior packet received from a first requesting ICA node and the interest packet received from a second requesting ICN node; and
identify a common ICN node based on the network configuration, the common ICN node in network communication with the first requesting ICN node and the second requesting ICN node;
wherein the determination of the packet route is further based on sending the named information through the common ICN node to the first requesting ICN node and the second requesting ICN node.

24. The non-transitory machine-readable storage medium of claim 22, wherein:
the ICN interest packet is received at a cellular ICN node within a cellular ICN network;
the cellular ICN network includes an ICN transmission user plane route and a cellular design control plane route; and
the determination of the packet route includes selecting the cellular design control plane route.

25. The non-transitory machine-readable storage medium of claim 22, the instructions further causing the processing circuitry to translate the received ICN interest packet into an IP request at a network translation orchestrator, wherein the determination of the packet route is further based on a route of the IP request to an IP network.
